(19) United States
(12) Patent Application Publication
(10) Pub. No.: US 2025/0132681 A1
(43) Pub. Date: Apr. 24, 2025

(54) AVERAGE INDUCTOR CURRENT SENSING AND REGULATION

(71) Applicant: Texas Instruments Incorporated, Dallas, TX (US)

(72) Inventor: Reza Sharifi, Sunnyvale, CA (US)

(21) Appl. No.: 18/632,695

(22) Filed: Apr. 11, 2024

Related U.S. Application Data
(60) Provisional application No. 63/591,144, filed on Oct. 18, 2023.

(51) Int. Cl. H02M 3/158; H02M 1/00; H02M 3/07

(52) U.S. Cl. CPC H02M 3/1582; H02M 1/0009; H02M 3/07

(57) ABSTRACT

Current regulation circuits and techniques. In one example, a circuit includes a voltage regulator circuit, current sensing circuitry, and a current control loop. The voltage regulator circuit is coupled to an output terminal of a DC-DC power converter and configured to produce a regulation signal based on a voltage at a regulator input terminal. The current sensing circuitry is coupled to a switching terminal of the DC-DC power converter and configured to produce a pulse signal based on a voltage at the switching input terminal and a threshold set by the regulation signal. The current control loop is coupled to control terminals of switching transistors of the DC-DC power converter and configured to generate switching control signals, based on the pulse signal, to control the switching transistors to drive an average value of a current flowing through the switching terminal to a target average current value corresponding to the threshold.

### CROSS REFERENCE TO RELATED APPLICATION

This application claims priority to U.S. Provisional Patent Application No. 63/591,144 filed on Oct. 18, 2023 and titled “Continuous Inductor Average Current Sensing and Current Loop Control,” which is hereby incorporated herein by reference in its entirety for all purposes.

### TECHNICAL FIELD

This description relates to power converters, and more particularly, to current sensing and control in DC-DC power converters.

### BACKGROUND

Power conversion circuits are used in a wide range of applications. For example, in battery management systems, power conversion circuits can be used to control battery charging with regulated voltages and/or currents. Accurate average input or output current regulation can be desirable in some applications. However, a number of non-trivial issues remain with respect to providing accurate and efficient average current regulation.

### SUMMARY

According to one example, a circuit comprises a voltage regulator circuit having a regulator input terminal for coupling to an output terminal of a DC-DC power converter, and a regulator output terminal, the voltage regulator circuit configured to produce, at the regulator output terminal, a regulation signal based on a voltage at the regulator input terminal. The circuit may further comprise current sensing circuitry having at least one switching input terminal, a sense input terminal, and a sense output terminal, the at least one switching input terminal for coupling to at least one switching terminal of the DC-DC power converter, and the sense input terminal coupled to the regulator output terminal, the current sensing circuitry configured to produce a pulse signal at the sense output terminal, wherein the pulse signal is based on a voltage at the at least one switching input terminal and an adjustable threshold value, set by the regulation signal. The circuit may further comprise a current control loop circuit having a loop input terminal coupled to the sense output terminal, and one or more control output terminals each for coupling to a control terminal of a corresponding switching transistor of the DC-DC power converter, the current control loop circuit configured to generate switching control signals at the one or more control output terminals based on the pulse signal, wherein the switching control signals are pulse width modulated signals to control the one or more switching transistors to drive an average value of a current flowing through the at least one switching terminal to a target average current value corresponding to the adjustable threshold value.

According to another example, a DC-DC power converter has an input terminal and an output terminal, and comprises a power conversion circuit including a plurality of power transistors and having at least one switching terminal for coupling, via an inductor, to at least one of the input terminal or the output terminal, the plurality of power transistors configured to generate a current through the at least one switching terminal based on control signals received via individual control terminals, and a voltage regulator circuit having a regulator input coupled to the output terminal, and a regulator output, the voltage regulator circuit configured to produce, at the regulator output, a regulation signal based on a voltage at the output terminal. The DC-DC power converter may further comprise current sensing circuitry coupled to the power conversion circuit and having a sense output and a sense input, the sense input coupled to the regulator output, the current sensing circuitry configured to produce, at the sense output, a pulse signal having a duty cycle that represents a percentage of time that current flowing through the at least one switching terminal is above a target value, and a current control loop circuit having a control loop input and a plurality of control loop outputs, the control loop input coupled to the sense output, and each of the control loop outputs coupled to a corresponding one of the control terminals, the current control loop circuit configured to generate the control signals as pulse width modulated signals based on the pulse signal to control the plurality of power transistors to adjust the current through at the at least one switching terminal to the target value.

According to another example, a buck-boost DC-DC converter comprises a first power transistor coupled between an input terminal and a first switching terminal, a second power transistor coupled between an output terminal and a second switching terminal, and a voltage regulator having a first regulator input coupled to the output terminal, a second regulator input for receiving a reference voltage, and a regulator output. The buck-boost DC-DC converter may further comprise a first variable current source coupled between the input terminal and a ground terminal, and having a first current control input coupled to the regulator output, a first sense transistor coupled between the input terminal and the first variable current source and having a control terminal coupled to a first control terminal of the first power transistor, and a first comparator having first and second comparator inputs and a first comparator output, the first comparator input coupled to the first switching terminal, and the second comparator input terminal coupled to the first sense transistor and the first variable current source, such that the first variable current source is coupled between the second comparator input and the ground terminal. The buck-boost DC-DC converter may further comprise a second variable current source coupled between the second switching terminal and the ground terminal, and having a second current control input terminal coupled to the regulator output terminal, a second sense transistor coupled between the second variable current source and the second switching terminal, and having a control terminal coupled to a second control terminal of the second power transistor, and a second comparator having a second comparator output, a third comparator input coupled to the output terminal, and a fourth comparator input coupled to the second sense transistor and the second variable current source, such that the second variable current source is coupled between the fourth comparator input and the ground terminal. The buck-boost DC-DC converter may further comprise a current control loop coupled to first and second comparator outputs and to the first and second control terminals of the first and second power transistors, respectively, the current control loop configured to generate first and second control signals at the first and second control terminals, respectively, based on signals at the first and second comparator outputs.

According to another example, a control circuit for a DC-DC power converter comprises a voltage regulator circuit having a first regulator input terminal for coupling to an output terminal of the DC-DC power converter, a second regulator input terminal for receiving a reference voltage, and a regulator output terminal, the voltage regulator circuit configured to produce, at the regulator output terminal, a regulation signal based on a difference between a voltage at the first regulator input terminal and a reference voltage. The control circuit may further comprise current sensing circuitry having at least one sensing terminal for coupling to at least one switching terminal of the DC-DC power converter, a sense output terminal, and at least one sense control terminal coupled to the regulator output terminal, the current sensing circuitry configured to produce, at the sense output terminal, a pulse signal having a duty cycle that represents a percentage of time that a current through the at least one switching terminal is above a target value that is based on the regulation signal, and a current control loop circuit having a loop input terminal coupled to the sense output terminal, and one or more control output terminals for coupling to power transistors, the current control loop circuit configured to generate, based on the pulse signal, control signals at the one or more control output terminals to control the power transistors to adjust the current through at the at least one switching terminal to the target value.

According to another example, a buck-boost DC-DC power converter comprises an input terminal, an output terminal, power conversion circuitry coupled to the input terminal and the output terminal and having first and second switching terminals for coupling to an inductor, the power conversion circuitry including a plurality of power transistors, and a current control circuit coupled to the power conversion circuitry and configured to generate, based on a regulation signal, one or more control signals to control the plurality of power transistors to provide a regulated current. The buck-boost DC-DC power converter may further comprise a regulator circuit coupled to the output terminal and to the power conversion circuitry, the regulator circuit having a regulator output terminal and configured to produce, at the regulator output terminal, the regulation signal representative of an average inductor current flowing through the first and second switching terminals, and a current conversion circuit coupled to the regulator output terminal and to the current control circuit, the current conversion circuit configured to adjust the regulation signal based on a limit signal representing a limit value for the regulated current.

According to one example, a buck-boost DC-DC power converter comprises an input terminal, an output terminal, first and second switching terminals for coupling to an inductor, and a plurality of power transistors, including a first power transistor coupled between the input terminal and the first switching terminal. The buck-boost DC-DC power converter may further comprise a voltage regulator circuit including a first regulator input terminal coupled to the output terminal, a second regulator input terminal for receiving a reference voltage, and a regulator output terminal, the voltage regulator circuit configured to provide, at the regulator output terminal, a regulation signal representative of a target average inductor current flowing through the first and second switching terminals, a current control circuit configured to regulate an input current at the input terminal to maintain the input current below a limit value, the current control circuit having a control output terminal coupled to a control terminal of the first power transistor and configured to provide a first control signal at the control output terminal, and a current conversion circuit. The current conversion circuit may comprise a switch circuit having a switch control terminal coupled to the control output terminal, a first transconductance amplifier having a first amplifier input terminal coupled to the switch circuit, a second amplifier input terminal for receiving a limit signal, and a first amplifier output terminal, wherein the limit signal represents the limit value for the input current at the input terminal, a second transconductance amplifier having a third amplifier input terminal coupled to the regulator output terminal, a fourth amplifier input terminal coupled to the first amplifier output terminal, and a second amplifier output terminal, and a transistor coupled between the regulator output terminal and a ground terminal and having a control terminal coupled to the second amplifier output terminal.

According to another example, a buck-boost DC-DC power converter comprises an input terminal, an output terminal, first and second switching terminals for coupling to an inductor, and a plurality of power transistors, including a first power transistor coupled between the output terminal and the second switching terminal. The buck-boost DC-DC power converter may further comprise a voltage regulator circuit including a first regulator input terminal coupled to the output terminal, a second regulator input terminal for receiving a reference voltage, and a regulator output terminal, the voltage regulator circuit configured to provide, at the regulator output terminal, a regulation signal representative of a target average inductor current flowing through the first and second switching terminals, a current control circuit configured to regulate an output current at the output terminal to maintain the output current below a limit value, the current control circuit having a control output terminal coupled to a control terminal of the first power transistor and configured to provide a first control signal at the control output terminal, and a current conversion circuit. The current conversion circuit may comprise a switch circuit having a switch control terminal coupled to the control output terminal, a transconductance amplifier having a first amplifier input terminal coupled to the switch circuit, a second amplifier input terminal for receiving a limit signal, and an amplifier output terminal, wherein the limit signal represents the limit value for the output current at the output terminal, and a transistor coupled between the regulator output terminal and a ground terminal and having a control terminal coupled to the amplifier output terminal.

### BRIEF DESCRIPTION OF THE DRAWINGS

FIG. 1A is a block diagram of a power conversion system, in an example.

FIG. 1B is a block diagram of a power conversion system in another example.

FIG. 2A is a circuit diagram illustrating portions of the power conversion system of FIG. 1A, in an example.

FIG. 2B is a circuit diagram illustrating further portions of the power conversion system of FIG. 1A, in an example.

FIG. 3 is a graph illustrating an inductor current signal and a corresponding pulse signal, in an example.

FIG. 4 is a circuit diagram illustrating portions of the power conversion system of FIG. 1B, in an example.

FIG. 5 is a circuit diagram illustrating a current conversion circuit in a buck-boost power converter, in an example.

FIG. 6 is a circuit diagram illustrating another current conversion circuit in a buck-boost power converter, in an example.

### DETAILED DESCRIPTION

Techniques are described for current regulation in DC-DC power converter circuits. As described in more detail below, techniques are disclosed whereby average inductor current (as opposed to peak or valley, for example) can be sensed in an accurate and lossless manner, and used to regulate a chosen quantity (e.g., average input or output current) in a DC-DC power converter. The inductor is coupled to at least one switching terminal of the DC-DC power converter. According to certain examples, a control loop is provided that allows for continuous adjustment of a threshold that can be used to generate a signal that represents average inductor current. This control loop can be used in a feedback loop to regulate the chosen quantity, without the need for lossy sense elements (such as sense resistors, for example). In some examples, an error voltage from the feedback loop is converted into a target average inductor current, which is passed to the control loop to adjust the threshold. The control loop may modulate the duty cycle of one or more of the power converter transistors to regulate the average inductor current to the target value, thereby regulating the chosen quantity (e.g., input or output current of the DC-DC power converter).

In an example, a circuit comprises a voltage regulator circuit having a regulator input terminal for coupling to an output terminal of a DC-DC power converter, and a regulator output terminal. The voltage regulator circuit can be configured to produce, at the regulator output terminal, a regulation signal based on a voltage at the regulator input terminal. In some examples, the voltage at the regulator input terminal is representative of the voltage at an output terminal of the DC-DC power converter. In an example, the circuit further comprises current sensing circuitry having at least one switching input terminal, a sense input terminal, and a sense output terminal, the at least one switching input terminal for coupling to at least one switching terminal of the DC-DC power converter, and the sense input terminal coupled to the regulator output terminal. The current sensing circuitry may be configured to produce a pulse signal at the sense output terminal, the pulse signal being based on a voltage at the at least one switching input terminal and an adjustable threshold value that is set by the regulation signal. The circuit may further comprise a current control loop circuit having a loop input terminal coupled to the sense output terminal, and one or more control output terminals each for coupling to a control terminal of a corresponding switching transistor of the DC-DC power converter. The current control loop circuit can be configured to generate switching control signals at the one or more control output terminals based on the pulse signal, wherein the switching control signals are pulse width modulated signals to control the one or more switching transistors to drive an average value of a current flowing through the at least one switching terminal to a target average current value corresponding to the adjustable threshold value. These and other aspects are described in more detail below.

### General Overview

Monitoring and regulation of inductor current in DC-DC power converters can be advantageous in many applications. However, as noted above, a number of non-trivial issues remain with respect to inductor current monitoring and control in DC-DC power converters. For instance, some approaches to monitoring and control of inductor current are either based on peak current detection or emulation of inductor current by using a resistive-capacitive (RC) filter across the inductor. Such approaches can be complex and/or inaccurate. For example, using a sense element, such as a resistor or RC filter across the inductor, introduces inefficiency, loss, and added cost. In addition, using an RC filter across the inductor may be very inaccurate because the inductor DC resistance (DCR) may not be known and can vary with temperature from device to device. Another approach to inductor current sensing involves continuously sensing the current through the switching transistors coupled to the inductor via the switching terminal(s) of the DC-DC converter, and then integrating the current (or corresponding voltage) to reconstruct the inductor current. However, there is significant complexity to continuously sensing the current (e.g., monitoring the complete waveform of the current). In addition, as the switching transistors turn on and off at a relatively rapid switching rate, significant switching noise can be introduced into the measurements, further adding complexity and/or inaccuracy to the current monitoring.

Accordingly, techniques are disclosed herein by which the average (as opposed to peak or valley, for example) inductor current can be accurately sensed in a lossless manner. Furthermore, techniques disclosed herein make accurate average inductor current information available for a variety of uses, as described further below. For example, various applications, including regulation of the DC-DC converter input or output current, for example, do not require continuous inductor current information. Rather, knowledge of the inductor current at a particular time in the switching cycle, or knowledge of the average inductor current, suffices. In addition, accurate average inductor current sensing according to certain examples may allow for more efficient use of the full capabilities of the inductor (e.g., providing more output power), which can be advantageous in applications such as power source management, current limiting, and/or phase management in case of multi-phase converters. More efficient use of the inductor allows for a smaller inductor to be used, thereby providing savings in terms of die area and/or height, and associated cost. The circuitry can be used in a variety of different DC-DC power converter configurations, including buck converters or buck-boost converters, for example. As described in more detail below, the circuitry can include a control loop to regulate the average inductor current to a target value, and a feedback loop that uses the average inductor current to regulate another quantity in the DC-DC power converter, such as average input or output current, for example.

### Example Architecture

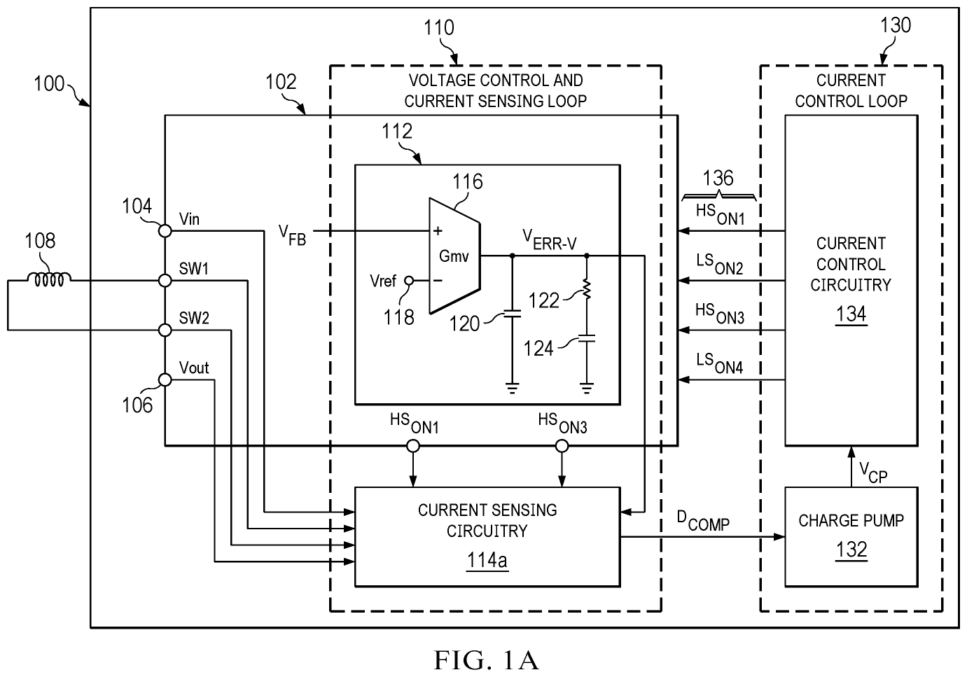

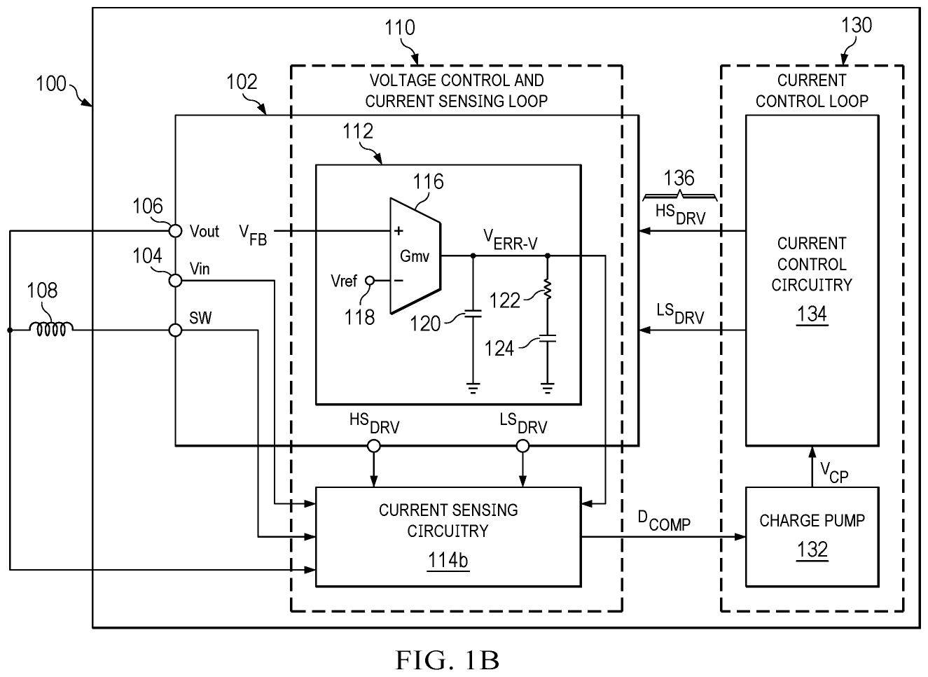

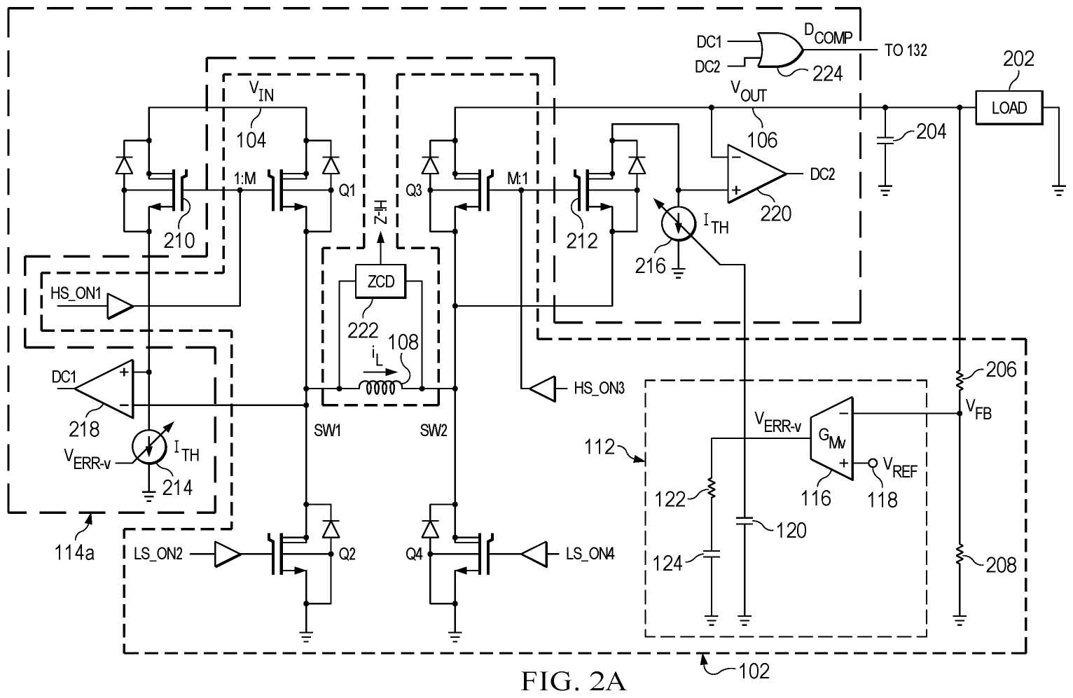

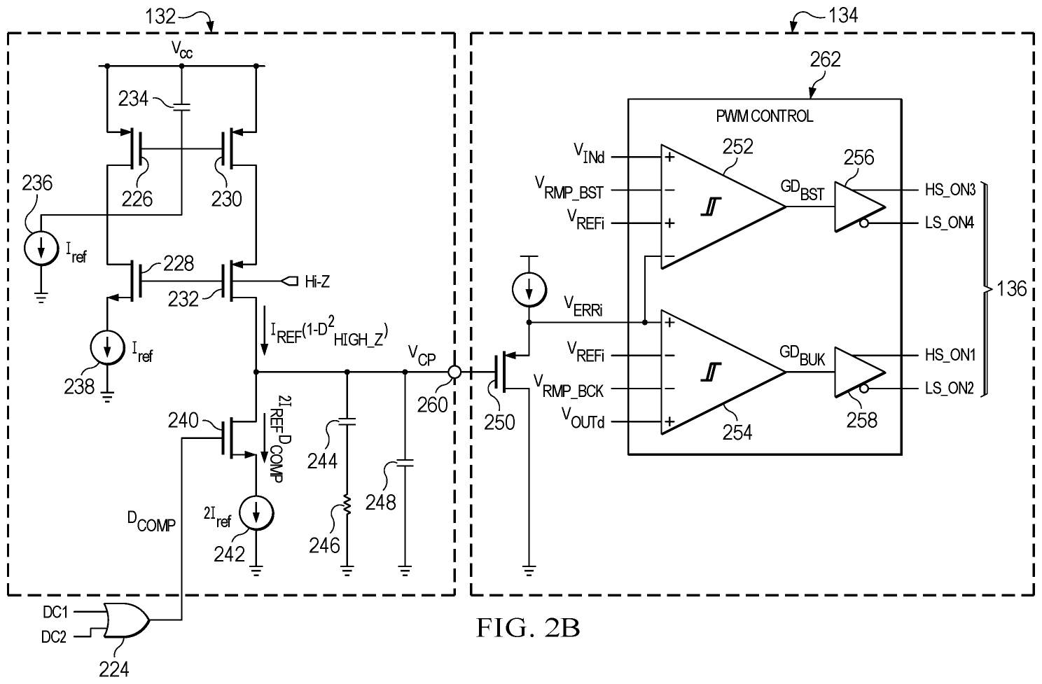

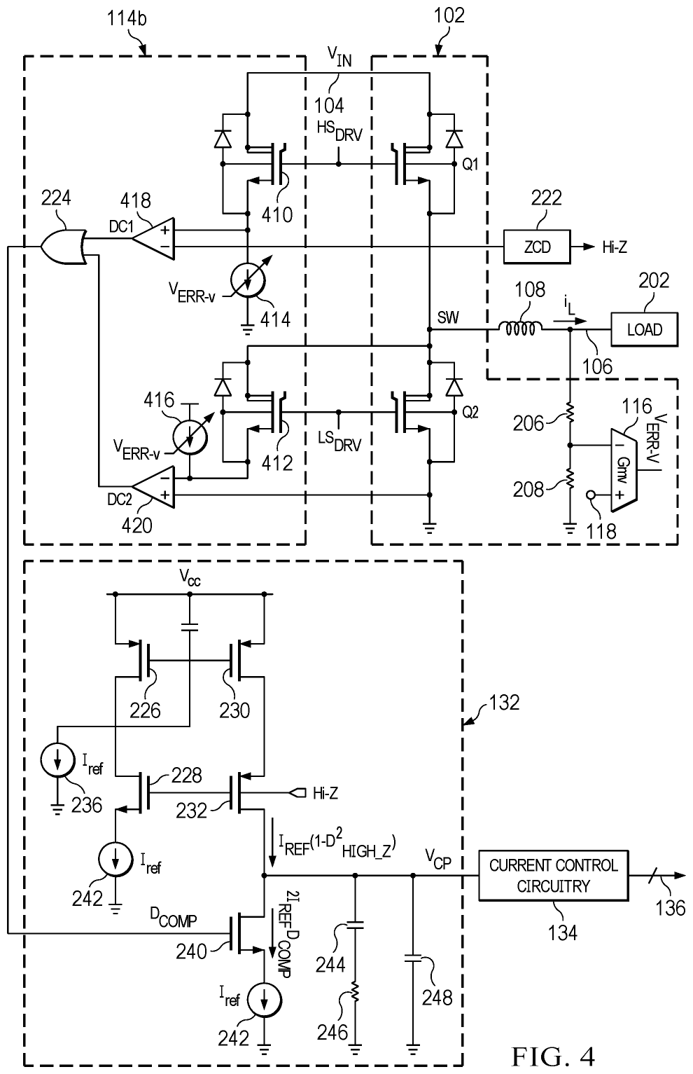

FIGS. 1A and 1B are block diagrams of a DC-DC power converter 100 that includes circuitry for average inductor current sensing and control, according to certain examples. The DC-DC power converter 100 includes a power conversion circuit 102 that includes a plurality of transistors, such as high-power field effect transistors (FETs), for example, as described further below with reference to FIGS. 2A and 4. The power conversion circuit 102 includes an input voltage terminal 104 for receiving an input voltage (Vin) and an output voltage terminal 106 for providing a regulated output voltage (Vout). In the example, of FIG. 1A, the DC-DC power converter 100 may be a two-level buck-boost converter (e.g., as shown in FIG. 2A) for example. Accordingly, in this example, the power conversion circuit 102 includes two switching terminals, SW1 and SW2, for coupling to an external inductor 108. In the example of FIG. 1B, the DC-DC power converter 100 may be a two-level buck converter (e.g., as shown in FIG. 4), for example. Accordingly, in this example, the power conversion circuit 102 includes a switching terminal SW for coupling to the external inductor 108. In other examples, the DC-DC converter 100 may be another type of multi-level switching power converter, such as a boost converter or three-level or higher order switching converter.

According to certain examples, the DC-DC power converter 100 includes a voltage control and current sensing loop 110 and a current control loop 130. The voltage control and current sensing loop 110 includes a voltage regulator 112 and current sensing circuitry 114a (FIG. 1A) or 114b (FIG. 1B). In some examples, the voltage regulator 112 includes a transconductance amplifier 116 having a first input terminal for receiving a voltage representative of the output voltage, Vout, referred to as a feedback voltage, V_{FB}, and a second input terminal coupled to a reference terminal 118 for receiving a reference voltage, Vref. The voltage regulator 112 may be configured to produce an error voltage, V_{ERR-V}, also referred to herein as a regulation signal, based on a difference between the feedback voltage, V_{FB}, and the reference voltage, Vref. In some examples, the regulation signal, V_{ERR-V}, is produced at an output terminal of the transconductance amplifier 116 across a resistive-capacitive (RC) filter. In the examples illustrated in FIGS. 1A and 1B, the RC filter includes a first capacitor 120 coupled between the output terminal of the transconductance amplifier 116 and a ground terminal, and a series combination of a resistor 122 and a second capacitor 124, the series combination being coupled in parallel with the first capacitor 120 between the output terminal of the transconductance amplifier 116 and the ground terminal. The regulation signal, V_{ERR-V}, may be used as a feedback signal in the voltage control and current sensing loop 110 to regulate the output voltage, Vout, to a selected value based on the reference voltage, Vref.

Referring to FIG. 1A, in some examples, the current sensing circuitry 114a is coupled to the input voltage terminal 104, the output voltage terminal 106, and the two switching terminals SW1, SW2. The current sensing circuitry 114a is further coupled to the output terminal of the transconductance amplifier 116 to receive the regulation signal, V_{ERR-V}. According to certain examples, the current sensing circuitry 114a is configured to sense, via the switching terminals SW1, SW2, an average current flowing through the inductor 108 (“inductor current”) by comparing the inductor current against an adjustable threshold that is set based on the regulation signal, V_{ERR-V}. To sense the inductor current, the current sensing circuitry 114a may include sensing transistors that are driven by control signals 136 (e.g., HS_{ON1}, HS_{ON3}) that are also used to drive high-side switching transistors in the power conversion circuit 102, as described in more detail below with reference to FIGS. 2A and 2B. In some examples, the current sensing circuitry 114a produces a pulsed output signal (“pulse signal”), D_{COMP}, based on the average inductor current, as described further below.

According to certain examples, the current control loop 130 includes a charge pump circuit 132 and current control circuitry 134. The charge pump circuit 132 may receive the pulse signal, D_{COMP}, from the current sensing circuitry 114a and convert the signal, D_{COMP}, into a voltage, VCP, that is provided to the current control circuitry 134. Based on the charge pump output voltage, VCP, which represents the average inductor current, the current control circuitry 134 may generate control signals 136 that are used to drive switching transistors in the power conversion circuit 102. The control signals 136 may adjust an on/off duty cycle of one or more of the switching transistors in the power conversion circuit 102, thereby regulating the inductor current to a target value corresponding to the threshold set by the regulation signal, V_{ERR-V}. Examples of the charge pump circuit 132 and the current control circuitry 134, and their operation, are described in more detail below with reference to FIGS. 2A and 2B.

Referring to FIG. 1B, in some examples, the current sensing circuitry 114b is coupled to the input voltage terminal 104, the output voltage terminal 106, the switching terminal SW, and the output terminal of the transconductance amplifier 116. The current sensing circuitry 114b may be configured to sense, via the switching terminal SW, the average current flowing through the inductor 108 by comparing the inductor current against the adjustable threshold set based on the regulation signal, V_{ERR-V}, as described above. The current sensing circuitry may include sensing transistors that are driven by the control signals 136 (e.g., HS_{DRV}, LS_{DRV} in this example) that are also used to drive switching transistors in the power conversion circuit 102, as described in more detail below with reference to FIG. 4.

In the example of FIG. 1B, the current control circuitry 134 produces the controls signals 136 (e.g., the signals HS_{DRV} and LS_{DRV}) based on the voltage, VCP, from the charge pump circuit 132, as described above with reference to FIG. 1A.

Referring now to FIG. 2A, there is illustrated a portion of the DC-DC converter 100 of FIG. 1A having a buck-boost configuration, according to one example. In the illustrated example, a load 202 is coupled to the output voltage terminal 106. The DC-DC converter 100 can be configured to deliver an output signal, such as the output voltage, Vout, to drive the connected load 202. As described above, the DC-DC converter 100 may receive an input signal, such as the input voltage, Vin, at the input voltage terminal 104, and when powered, converts the input voltage, Vin, to provide the output voltage signal, Vout. An output capacitor 204 is coupled between the output voltage terminal 106 and a ground terminal. In the illustrated example, one input terminal of the transconductance amplifier 116 is coupled to the output voltage terminal 106 via a resistive divider to receive the feedback voltage, V_{FB}, as described above. The resistive divider may include resistors 206 and 208 coupled in series between the output voltage terminal 106 and the ground terminal. Thus, the feedback voltage, V_{FB}, may be produced at a center terminal that joins the two resistors 206, 208, as shown. In other examples, the feedback voltage, V_{FB}, may be taken directly from the output voltage terminal 106. In some examples, the DC-DC converter 100 is configured to provide closed loop regulation of the output voltage, Vout, according to the voltage reference signal, Vref, supplied at the reference terminal 118. As described above, the voltage regulator 112 produces the regulation signal, V_{ERR-V}, based on a difference between the feedback voltage, V_{FB}, and the reference voltage, Vref, supplied at the reference terminal 118.

In the example of FIG. 2A, the power conversion circuit 102 includes a first high-side transistor Q1, a first low-side transistor Q2, a second high-side transistor Q3, and a second low-side transistor Q4. The first high-side transistor Q1 is coupled between the input voltage terminal 104 and the first switching terminal SW1, and the first low-side transistor Q2 is coupled between the first switching terminal SW1 and the ground terminal. Similarly, the second high-side transistor Q3 is coupled between the output voltage terminal 106 and the second switching terminal SW2, and the second low-side transistor Q4 is coupled between the second switching terminal SW2 and the ground terminal. The inductor 108 is coupled between the first and second switching terminals, SW1 and SW2. Control terminals (e.g., gates) of the four transistors Q1, Q2, Q3, and Q4 are driven by the control signals 136, in this example, HS_{ON1}, LS_{ON2}, HS_{ON3}, and LS_{ON4}, respectively. In some examples, the transistors Q1, Q2, Q3, Q4, are power FETs (e.g., n-channel or p-channel MOSFET devices); however, other transistor technology may be used in other examples. As the transistors Q1-Q4 are switched on and off according to the control signals 136, current flows into the inductor 108 and from the inductor 108 to the connected load 202 thus producing a varying inductor current, i_{L}, that can be sensed at the switching terminals, SW1, SW2.

According to certain examples, the current sensing circuitry 114a includes a first sense transistor 210 coupled to the first high-side transistor Q1 and a second sense transistor 212 coupled to the second high-side transistor Q3. The current sensing circuitry 114a may further include a first adjustable current source 214 and a second adjustable current source 216. In the illustrated example, the first sense transistor 210 is coupled between the input voltage terminal 104 and the first adjustable current source 214, and has a control terminal coupled to the control terminal of the first high-side transistor Q1 and driven by the control signal HS_{ON1}. In the illustrated example, the first high-side transistor Q1 is an n-channel MOSFET (e.g., NMOS) switching transistor coupled to turn on according to a corresponding HIGH first control signal 136 (HS_{ON1}). Accordingly, in this example, the first high-side transistor Q1 has a drain terminal coupled to the input voltage terminal 104, a source terminal coupled to the first switching terminal SW1, and a gate control terminal to receive the first control signal HS_{ON1}. In some examples, the first sense transistor 210 is a same type of transistor as the first high-side transistor Q1, and a ratio of the transistor size (e.g., gate width) between the first sense transistor 210 and the first high-side transistor Q1 is 1:M (e.g., the first high-side transistor Q1 is M times larger than the first sense transistor 210). Thus, in the illustrated example, the first sense transistor 210 has a drain terminal coupled to the input voltage terminal 104, a source terminal coupled to the first adjustable current source 214, and a gate control terminal coupled to the gate control terminal of the first high-side transistor Q1 to receive the first control signal, HS_{ON1}.

Similarly, in the illustrated example, the second high-side transistor Q3 is an NMOS switching transistor coupled to turn on according to a corresponding HIGH second control signal 136 (HS_{ON3}). Accordingly, in this example, the second high-side transistor Q3 has a drain terminal coupled to the output voltage terminal 106, a source terminal coupled to the second switching terminal SW2, and a gate control terminal to receive the second control signal HS_{ON3}. In some examples, the second sense transistor 212 is a same type of transistor as the second high-side transistor Q3, and a ratio of the transistor size (e.g., gate width) between the second sense transistor 212 and the second high-side transistor Q3 is 1:M (e.g., the second high-side transistor Q3 is M times larger than the second sense transistor 212). In the illustrated example, the second sense transistor 212 has a drain terminal coupled to the second adjustable current source 216, a source terminal coupled to the second switching terminal SW2, and a gate control terminal coupled to the gate control terminal of the second high-side transistor Q3 to receive the second control signal, HS_{ON3}. Thus, the first and second sense transistors 210, 212 may be switched synchronously with the first and second high-side transistors Q1 and Q3, respectively, and used to sense the current flowing in the first and second high-side transistors and thus the corresponding inductor current, i_{L}.

Still referring to FIG. 2A, in the illustrated example, the first and second low-side transistors Q2 and Q4 are NMOS switching transistors that are coupled between the first and second switching terminals SW1, SW2, respectively, and the ground terminal. Thus, in one example, the first low-side transistor Q2 has a drain terminal coupled to the first switching terminal SW1, a source terminal coupled to the ground terminal, and a gate control terminal to receive a third control signal LS_{ON2}. Similarly, the second low-side transistor Q4 has a drain terminal coupled to the second switching terminal SW2, a source terminal coupled to the ground terminal, and a gate control terminal to receive a fourth control signal LS_{ON4}.

In some examples, the current sensing circuitry 114a further includes a first comparator 218 and a second comparator 220. The first comparator 218 has a first comparator input terminal (labeled “+”) coupled to the source terminal of the first sense transistor 210 and to the first adjustable current source 214, and a second comparator input terminal (labeled “−”) coupled to the first switching terminal SW1. The first comparator 218 is configured to produce a first comparator output signal, DC1, based on a difference between the signals at its two input terminals. The second comparator 220 has a first comparator input terminal (labeled “+”) coupled to the drain terminal of the second sense transistor 212 and to the second adjustable current source 216, and a second comparator input terminal (labeled “−”) coupled to the output voltage terminal 106, as shown in FIG. 2A. Like the first comparator 218, the second comparator 220 is configured to produce a second comparator output signal, DC2, based on a difference between the signals at its two input terminals.

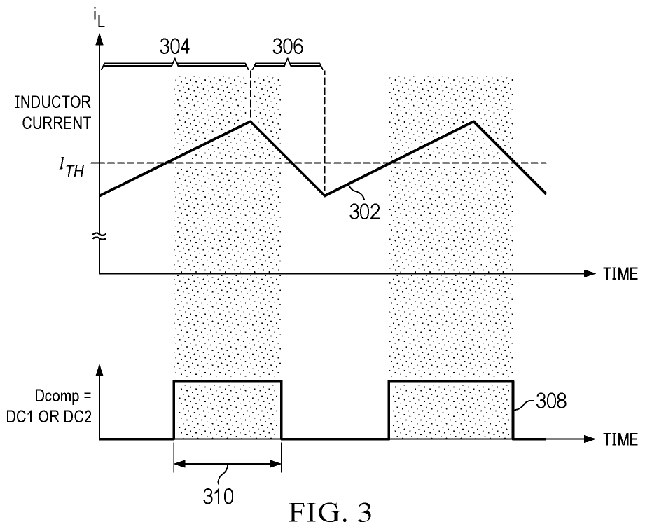

According to certain examples, the individual comparators 218, 220 produce the respective comparator output signals, DC1, DC2 that are HIGH (e.g., logic or binary 1) when the inductor current, i_{L}, is above the threshold value, I_{TH}. For example, referring to FIG. 3, there is illustrated a graph showing an example of the inductor current, i_{L}, represented by trace 302. During a first mode 304 (e.g., a buck mode of operation in examples in which the DC-DC converter 100 has a buck-boost configuration), current flows from the input voltage terminal 104, via the first high-side transistor Q1 into the inductor 108, and during a second mode 306 (e.g., a boost mode of operation), current flows from the inductor 108 to the connected load 202 at the output voltage terminal 106 via the second high-side transistor Q3. Accordingly, during the first mode 304, the inductor current, it, is sensed using the first sense transistor 210 and the first comparator 218 produces the first comparator output signal, DC1, that is HIGH when the inductor current, i_{L}, is above the threshold value, I_{TH}. During the second mode 306, the inductor current, it, is sensed using the second sense transistor 212 and the second comparator 220 produces the second comparator output signal, DC2, that is HIGH when the inductor current, i_{L}, is above the threshold value, I_{TH}. The amount of time during a given switching or commutation cycle (combination of the two modes 304, 306) for which the inductor current, i_{L}, exceeds the threshold value, I_{TH}, can be controlled by controlling the switching duty cycle of the high-side transistors Q1 and Q3 via the control signals 136.

As illustrated in FIG. 2A, in some examples, the current sensing circuitry 114a further includes a digital logic gate 224 (an OR gate in the example of FIG. 2A) that receives the two comparator output signals, DC1 and DC2, and produces the pulse signal, D_{COMP}. In some examples, because the pulse signal, D_{COMP}, has a value corresponding to the OR combination of the comparator output signals, DC1 and DC2, the pulse signal, D_{COMP}, is HIGH when the inductor current, it, is above the threshold value I_{TH}. Thus, referring to FIG. 3, the pulse signal, D_{COMP}, (represented by trace 308) has a duty cycle 310 (portion of the commutation cycle for which the pulse signal is HIGH) that represents a percentage of time that an inductor current, i_{L}, is above the threshold value (I_{TH}). Thus, if the pulse signal has a 50% duty cycle 310, the average inductor current, i_{L}, corresponds to the threshold value, I_{TH}.

According to certain examples, the threshold value, I_{TH}, is set by the adjustable current sources 214, 216. As illustrated in FIG. 2A, the adjustable current sources 214, 216 may be controlled by the regulation signal, V_{ERR-V}, and thus the threshold value, I_{TH}, may be controlled or set by the regulation signal. As described above, in some examples, the voltage regulator 112 regulates the output voltage, Vout, at the output voltage terminal 106 based on the reference voltage, Vref, at the reference voltage terminal 118, and produces the regulation signal, V_{ERR-V}, as a feedback signal in voltage control and current sensing loop 110. According to certain examples, by using the regulation signal, V_{ERR-V}, to set the threshold value, I_{TH}, the regulation signal becomes target value for the average inductor current, i_{L}. In some examples, the current control loop 130 can be configured to compare the duty cycle of the pulse signal, D_{COMP}, to 50% and to generate the control signals 136 to adjust the switching duty cycle of the transistors Q1-Q4 so as to drive the inductor current, i_{L}, to the target average value (I_{TH}) set by the regulation signal, V_{ERR-V}. Thus, as described above, examples of the DC-DC converter 100 operate two control loops to implement a current mode control technique using average inductor current information. A first control loop, implemented with the voltage control and current sensing loop 110, controls a parameter/quantity to be regulated (such as the output voltage, Vout, or the input or output currents at the input voltage terminal 104 or output voltage terminal 106, respectively, as described further below), and a second control loop, implemented with the current control loop 130, controls the inductor current, i_{L}, based on the regulation signal, V_{ERR-V}, that is taken from the first control loop.

As described above, the current control loop 130 produces control signals 136 that are used to control the switching of the transistors Q1-Q4 (in the example of FIG. 2A) or Q1-Q2 (in the example of FIG. 4 described further below). In some examples, the control signals 136 are pulse width modulation (PWM) signals, each having a controlled duty cycle based on the pulse signal, D_{COMP}, as described further below.

Referring to FIG. 2B, there is illustrated an example of the current control loop 130. According to certain examples, the charge pump circuit 132 is configured to compare duty cycle 310 of the pulse signal, D_{COMP}, to 50%, as described above. Accordingly, in some examples, the charge pump circuit 132 is coupled to the output terminal of the digital logic gate 224 to receive the pulse signal, D_{COMP}, as shown. The charge pump circuit may generate, at its output terminal 260, a charge pump voltage signal, VCP, according to the duty cycle 310 of the pulse signal, D_{COMP}. In the illustrated example, the charge pump circuit 132 includes a first transistor 226, a second transistor 228, a third transistor 230, and a fourth transistor 232. In some examples, control terminals of the first transistor 226 and the third transistor 230 are connected together and to a first reference current source 236. A filtering capacitor 234 may be connected between a supply voltage rail, Vcc, and the control terminals of the first and third transistors 226, 230. In some examples, the first, third, and fourth transistors 226, 230, 232 are p-channel MOSFET switches (e.g., PMOS devices), and the second transistors 228 is an NMOS device. Accordingly, in the illustrated example, the first transistor 226 includes a source terminal coupled to the supply voltage rail, Vcc, and a drain terminal coupled to a drain terminal of the second transistor 228. The source terminal of the second transistor 228 is coupled to a second reference current source 238. The first and second reference current sources have a value of I_{REF}. The third transistor 230 has a source terminal coupled to the supply voltage rail, Vcc, and a drain terminal coupled to a source terminal of the fourth transistor 232. In some examples, the second and fourth transistors 228, 232 of the charge pump circuit 132 have gate control terminals that are connected together and coupled to a zero crossing detector (ZCD) circuit 222 (FIG. 2A) to receive a Hi-Z control signal from the ZCD circuit 222. A drain terminal of the fourth transistor 232 may generate the charge pump voltage signal, VCP, at the charge pump output terminal 260.

In some examples, the ZCD circuit 222 is coupled to the first and second switching terminals SW1, SW2, as shown in FIG. 2A. The ZCD circuit 222 compares a voltage at the switching terminals SW1 or SW2 to a ground voltage (e.g., zero volts). In operation, the ZCD circuit 222 provides the control signal Hi-Z to the charge pump circuit 132 based on the voltages at the switching terminals SW1, SW2, representative of the inductor current, i_{L}. For example, the ZCD circuit 222 may provide the signal Hi-Z in a first state (e.g., HIGH) when the inductor current, i_{L}, is zero, and may provide the Hi-Z signal in a second state (e.g., LOW) when the inductor current, i_{L}, is greater than zero. As described further below, in one example, the charge pump circuit 132 uses the Hi-Z signal to implement current regulation based on the pulse signal, D_{COMP}, in both continuous conduction mode (CCM) and discontinuous conduction mode (DCM) operating modes of the DC-DC power converter 100.

Referring again to FIG. 2B, according to certain examples, the charge pump circuit 132 includes a fifth transistor 240, which may be an NMOS device having a drain terminal coupled to the charge pump output terminal 260 and a control terminal coupled to the output terminal of the digital logic gate 224 to receive the pulse signal, D_{COMP}. The charge circuit 132 may further include a third reference current source 242 connected between a source terminal of the fifth transistor 240 and a ground terminal. The charge pump circuit 132 may further include an RC filter including a capacitor 244 and a resistor 246 coupled in series between the charge pump output terminal 260 and the ground terminal, and an integrating capacitor 248 connected between the charge pump output terminal 260 and the ground terminal. In this configuration, when the pulse signal D_{COMP} is HIGH, the fifth transistor 240 is turned on and conducts current from the charge pump output terminal 260 with an amplitude set by the third reference current source 242. When the pulse signal, D_{COMP} is low, the fifth transistor 240 is off. An error current flows from the charge pump output terminal 260 into the integrating capacitor 248. This error current is the sum of a current I_{REF}(1−D_{Hi-Z}²) from the fourth transistor 232 and a current 2I_{REF}D_{comp} flowing from the charge pump output terminal 260 to the fifth transistor 240.

According to certain examples, the charge pump circuit 132 operates to control the amplitude of the charge pump voltage signal, VCP, according to the duty cycle 310 of the pulse signal, D_{COMP}. The third reference current source 242 conducts a current with a value 2I_{REF}. Also, when the fourth transistor 232 is turned on (e.g., when the control signal Hi-Z is LOW), the current through the fourth transistor 232 is set by a current mirror circuit formed with the second transistor 226. This mirrored current flowing in the fourth transistor 232 is determined by a reference current value I_{REF} (from the first and second reference current sources 236, 238) and the duty cycle of the control signal Hi-Z. For CCM operation of the DC-DC converter 100, the control signal HI-Z remains LOW (e.g., because the inductor current in, remains above zero). The fourth transistor 232 thus remains on, and the current flowing in the fourth transistor 232 has a value of I_{REF}. In CCM operation, the voltage VCP across the integrating capacitor 248 is regulated to a value that is determined by the duty cycle of the pulse signal, D_{COMP}. For example, when the duty cycle of the pulse signal D_{COMP}, is 50%, the fifth transistor 240 is turned on for half the duration of each switching cycle of the DC-DC converter 100.

While the fifth transistor 240 is turned on, a current with a value of 2I_{REF} flows through the fifth transistor 240, and a current with a value of I_{REF} flows through the fourth transistor 232. In this state, the error current at the charge pump output terminal 260 has a value of −I_{REF} to discharge the integrating capacitor 248. The fifth transistor 240 is turned off for the remaining half of the switching cycle. With the fifth transistor 240 off, the error current at the charge pump output terminal 260 has a value of +I_{REF} to charge the integrating capacitor 248. When the duty cycle of the pulse signal, D_{COMP}, is 50%, the integrating capacitor 248 is alternately charged and discharged for equal amounts of time, and the average amplitude of the charge pump output voltage signal, VCP, is approximately constant. If the duty cycle of the pulse signal, D_{COMP}, deviates from 50% (indicating that the average inductor current, i_{L}, is above or below the target value, I_{TH}), the charging and discharging of the integrating capacitor 248 is unbalanced, and the average voltage VCP changes accordingly.

The charge pump circuit 132 may also accommodate DCM operation, as described above. In some examples, the second transistor 228 is turned on and the fourth transistor 232 is turned off in response to a HIGH Hi-Z signal state (e.g., when the inductor current in is zero). In this state, the error current at the charge pump output terminal 260 is set according to the current 2I_{REF}D_{comp} flowing through the fifth transistor 240 based on the duty cycle of the pulse signal, D_{COMP}, from the digital logic gate 224. The inductor current, i_{L}, reaches zero in portions of individual switching cycles of the DC-DC converter 100 for DCM operation. The inductor current, i_{L}, is non-zero for CCM operation and for portions of the switching cycles in DCM operation. In response to the inductor current, i_{L}, being non-zero, the Hi-Z signal is LOW, as described above, the second transistor 228 is turned off, and the fourth transistor 232 is turned on. In this state, the current flowing through the fourth transistor 232 into the charge pump output terminal 260 has a value of I_{REF}(1+D_{Hi-Z}). The current that flows through the fourth transistor 232 is I_{REF}(1+D_{Hi-Z}) during the state that the Hi-Z signal is LOW. Thus, on average, the current that flows is I_{REF}(1−D_{Hi-Z}²), as described above.

According to certain examples, the charge pump output voltage, VCP, is provided from the charge pump circuit 132 to the current control circuitry 134. The current control circuitry 134 may be configured to generate the control signals 136, based on the charge pump output voltage, VCP, which represents the average inductor current, i_{L}, as described above. Still referring to FIG. 2B, in some examples, the current control circuitry 134 includes a transistor 250 having a control terminal coupled to the charge pump output terminal 260 to receive the charge pump output voltage, VCP. The current control circuitry 134 may further include a PWM control circuit 262 that is configured to generate the control signals 136. The PWM control circuit 262 generates the signals 136, based in part on the charge pump output voltage, VCP, to control switching duty cycles of the transistors Q1-Q4 so as to regulate the average inductor current, i_{L}, to the target threshold value, I_{TH}, set by the regulation signal, V_{ERR-V}, as described above.

In examples in which the DC-DC converter 100 has a buck-boost configuration, the PWM control circuit 262 includes first and second hysteresis comparators 252, 254, that produce the control signals 136 for the boost and buck modes of operation, respectively. In some examples, the first hysteresis comparator 252 includes a first input terminal coupled to receive the input voltage, Vin, from the input voltage terminal 104, and a second input terminal coupled to receive a boost mode ramp carrier signal, V_{RMMP_BST}. The first hysteresis comparator 252 further includes a third input terminal coupled to receive a current control reference voltage, V_{REFi}, and a fourth input coupled to receive a current control error voltage, V_{ERRi}, that is based on the charge pump output voltage, VCP (and therefore representative of the error current flowing at the charge pump output terminal 260 described above). In operation, the first hysteresis comparator 252 modulates the boost mode ramp carrier signal, V_{RMP_BST}, based on the input voltage, Vin, and the current control reference voltage, V_{REFi}, with a duty cycle that is controlled by the current control error voltage, V_{ERRi}, to provide a boost mode control signal, GD_{BST}. The PWM control circuit 262 may further include a first dual-output buffer 256 coupled to the output terminal of the first hysteresis comparator 252 and having an inverter on one output. Thus, the PWM control circuit 262 produces, from the boost mode control signal, GD_{BST}, two complementary control signals, HS_{ON3} and LS_{ON4}, (e.g., two of the control signals 136) for controlling the second high-side transistor Q3 and the second low-side transistor Q4.

Similarly, in some examples, the second hysteresis comparator 254 includes a first input terminal coupled to receive the output voltage, Vout, from the output voltage terminal 106, and a second input terminal coupled to receive a buck mode ramp carrier signal, V_{RMP_BUK}. The second hysteresis comparator 254 further includes a third input terminal coupled to receive the current control reference voltage, V_{REFi}, and a fourth input terminal coupled to receive the current control error voltage, V_{ERRi}. In operation, the second hysteresis comparator 254 modulates the buck mode ramp carrier signal, V_{RMP_BUK}, based on the output voltage, Vout, and the current control reference voltage, V_{REFi}, with a duty cycle that is controlled by the current control error voltage, V_{ERRi}, to provide a buck mode control signal, GD_{BUK}. The PWM control circuit 262 may further include a second dual-output buffer 258 coupled to the output terminal of the second hysteresis comparator 254 and having an inverter on one output. Thus, the PWM control circuit 262 further produces, from the buck mode control signal, GD_{BUK}, two additional complementary control signals, HS_{ON1} and LS_{ON2}, (e.g., another two of the control signals 136) for controlling the first high-side transistor Q1 and the first low-side transistor Q2.

According to certain examples, the duty cycle of the output signals HS_{ON3} and LS_{ON4} represents a ratio or proportion of time in a given switching cycle during which second high-side transistor Q3 and the second low-side transistor Q4 are turned on. As described above, this duty cycle in turn controls the inductor current, i_{L}, during the second mode 306 and the amount of time during the second mode of each switching cycle for which the inductor current is above the threshold value, I_{TH}. Similarly, the duty cycle of the output signals HS_{ON1} and LS_{ON2} represents a ratio or proportion of time in a given switching cycle during which first high-side transistor Q1 and the first low-side transistor Q2 are turned on. This duty cycle in turn controls the inductor current, i_{L}, during the first mode 304 and the amount of time during the first mode of each switching cycle for which the inductor current is above the threshold value, I_{TH}. Thus, because the duty cycle of the control signals 136 is controlled by the charge pump output voltage, VCP, which represents the average inductor current relative to the threshold value, I_{TH}, the current control circuitry 134 regulates the average inductor current to the target threshold value, I_{TH}. Since the target threshold value, I_{TH}, is controlled by the regulation signal, V_{ERR-V}, from the voltage control and current sensing loop 110, the current control circuitry 134 regulates the inductor current according to regulation of the parameter controlled by the feedback loop (e.g., output voltage, Vout, output current, or input current). Thus, as described above, the combination of the voltage control and current sensing loop 110 and the current control loop 130 may operate as two linked feedback and control loops within the DC-DC converter 100. An “outer” feedback loop (including the voltage regulator 112) regulates a selected parameter/quantity (such as output voltage, output current, or input current) of the DC-DC converter 100, generating the regulation signal, which is then passed to the “inner” current control loop 130 to regulate the average inductor current accordingly.

In the examples of FIGS. 1A, 2A and 2B, the DC-DC converter 100 has a buck-boost configuration. However, the average inductor current sensing and control techniques described herein may be applied in other DC-DC converter topologies. For example, as described above with reference to FIG. 1B, the voltage control and current sensing loop 110 and the current control circuitry 134 can be implemented in the DC-DC converter 100 having a buck configuration.

Referring to FIG. 4, there is illustrated an example of the DC-DC converter 100 having a buck configuration and including the current sensing circuitry 114b described above. In this example, the power conversion circuit 102 includes the high-side transistor Q1 and the low-side transistor Q2. The high-side transistor Q1 is coupled between the input voltage terminal 104 and the switching terminal SW, and the low-side transistor Q2 is coupled between the switching terminal SW and the ground terminal. The inductor 108 is coupled between the switching terminal, SW, and the output voltage terminal 106. Control terminals (e.g., gates) of the transistors Q1 and Q2 are driven by the control signals 136, in this example, HS_{DRV} and LS_{DRV}, respectively. In some examples, the transistors Q1 and Q2 are power FETs (e.g., n-channel or p-channel MOSFET devices); however, other transistor technology may be used in other examples. As the transistors Q1 and Q2 are switched on and off according to the control signals 136, current flows into the inductor 108 and from the inductor 108 to the connected load 202, thus producing the varying inductor current, i_{L}, (e.g., as shown in FIG. 3) that can be sensed at the switching terminal, SW, as described above.

According to certain examples, the current sensing circuitry 114b includes a first sense transistor 410 coupled to the high-side transistor Q1 and a second sense transistor 412 coupled to the low-side transistor Q2. The current sensing circuitry 114b may further include a first adjustable current source 414 and a second adjustable current source 416. The adjustable current sources 414, 416 have a current, I_{TH}, that is controlled by the regulation signal, V_{ERR-V}, as described above. In the illustrated example, the first sense transistor 410 is coupled between the input voltage terminal 104 and the first adjustable current source 414, and has a control terminal coupled to the control terminal of the high-side transistor Q1 and driven by the control signal HS_{DRV}. In the illustrated example, the high-side transistor Q1 is an n-channel MOSFET (e.g., NMOS) switching transistor coupled to turn on according to a corresponding HIGH first control signal 136 (HS_{DRV}). Accordingly, in this example, the high-side transistor Q1 has a drain terminal coupled to the input voltage terminal 104, a source terminal coupled to the switching terminal SW, and a gate control terminal to receive the first control signal HS_{DRV}. In some examples, the first sense transistor 410 is a same type of transistor as the high-side transistor Q1, and a ratio of the transistor size (e.g., gate width) between the first sense transistor 410 and the high-side transistor Q1 is 1:M (e.g., the high-side transistor Q1 is M times larger than the first sense transistor 410). Thus, in the illustrated example, the first sense transistor 410 has a drain terminal coupled to the input voltage terminal 104, a source terminal coupled to the first adjustable current source 414, and a gate control terminal coupled to the gate control terminal of the high-side transistor Q1 to receive the first control signal, HS_{ON1}.

Similarly, in the illustrated example of FIG. 4, the low-side transistor Q2 is an NMOS switching transistor coupled to turn on according to a corresponding HIGH second control signal 136 (LS_{DRV}). Accordingly, in this example, the low-side transistor Q2 has a drain terminal coupled to the switching terminal SW, a source terminal coupled to the ground terminal, and a gate control terminal to receive the second control signal LS_{DRV}. In some examples, the second sense transistor 412 is a same type of transistor as the low-side transistor Q2, and a ratio of the transistor size (e.g., gate width) between the second sense transistor 412 and the low-side transistor Q2 is 1:M (e.g., the low-side transistor Q2 is M times larger than the second sense transistor 412). In the illustrated example, the second sense transistor 412 has a source terminal coupled to the second adjustable current source 416, a drain terminal coupled to the switching terminal SW, and a gate control terminal coupled to the gate control terminal of the low-side transistor Q2 to receive the second control signal, LS_{DRV}. Thus, the first and second sense transistors 410, 412 may be switched synchronously with the high-side and low-side transistors Q1 and Q2, respectively, and used to sense the current flowing in the high-side and low-side transistors and thus the corresponding inductor current, i_{L}.

Still referring to FIG. 4, in some examples, the current sensing circuitry 114b further includes a first comparator 418 and a second comparator 420, similar to the current sensing circuitry 114a described above. The first comparator 418 has a first comparator input terminal (labeled “+”) coupled to the source terminal of the first sense transistor 410 and to the first adjustable current source 414, and a second comparator input terminal (labeled “−”) coupled to the switching terminal SW. The first comparator 418 is configured to produce a first comparator output signal, DC1, based on a difference between the signals at its two input terminals. The second comparator 420 has a first comparator input terminal (labeled “+”) coupled to the ground terminal, and a second comparator input terminal (labeled “−”) coupled to the source terminal of the second sense transistor 412 and to the second adjustable current source 416. Like the first comparator 418, the second comparator 420 is configured to produce a second comparator output signal, DC2, based on a difference between the signals at its two input terminals.

According to certain examples, a voltage at the first comparator input terminal of the first comparator 418 is set by the signal from the first adjustable current source 414 (I_{TH}) and the on state resistance of the first sense transistor 410. The first comparator 418 provides the first comparator output signal, DC1, in a first state (e.g., HIGH) in response to the voltage signal at its first comparator input terminal being greater than the voltage at the switching terminal SW, or in a second state (e.g., LOW) in response to the voltage its first comparator input terminal being less than the voltage at the switching terminal SW. As the voltage at the switching terminal SW is related to the inductor current, i_{L}, the state of the first comparator output signal, DC1 (e.g., HIGH or LOW), depends on whether the inductor current, i_{L}, at the switching terminal SW is above or below the threshold value, I_{TH}, set by the first adjustable current source 414. Similarly, the second comparator 420 produces the second comparator output signal, DC2 having a state (e.g., HIGH or LOW) based on whether the inductor current, i_{L}, at the switching terminal SW is above or below the threshold value, I_{TH}, set by the second adjustable current source 416.

In the buck configuration, similar to the buck-boost configuration described above with reference to FIGS. 2A, 3, and 4, switching of the transistors Q1 and Q2 produces a varying inductor current, i_{L}, with a profile similar to that shown in FIG. 3. In the example of FIG. 4, the first sense transistor 410 senses the inductor current during the first mode 304 (e.g., Q1 is on and Q2 is off), and the second sense transistor 412 senses the inductor current during the second mode 306 (e.g., Q1 is off and Q2 is on). The individual comparators 418, 420 may thus produce the respective comparator output signals, DC1, DC2 that are HIGH when the inductor current, i_{L}, is above the threshold value, I_{TH}. As in the example of the current sensing circuitry 114a discussed above, the current sensing circuitry 114b may include the digital logic gate 224 (an OR gate in the example of FIG. 4) that receives the two comparator output signals, DC1 and DC2, and produces the pulse signal, D_{COMP}. Thus, as described above, because the pulse signal, D_{COMP}, has a value corresponding to the OR combination of the comparator output signals, DC1 and DC2, the pulse signal, D_{COMP}, is HIGH when the inductor current, it, is above the threshold value I_{TH}, and has a duty cycle 310 (FIG. 3) that represents a percentage of time that an inductor current, i_{L}, is above the threshold value (I_{TH}). The amount of time during a given switching cycle for which the inductor current, it, exceeds the threshold value, I_{TH}, can be controlled by controlling the switching duty cycle of the transistors Q1 and Q2 via the control signals 136. As in the example of FIGS. 2A and 2B, the threshold value, I_{TH}, is set by the adjustable current sources 414, 416, which are controlled by the regulation signal, V_{ERR-V}.

Still referring to FIG. 4, in this example, the pulse signal, D_{COMP}, is provided to the charge pump circuit 132, which operates as described above (with reference to FIG. 2B) to produce the charge pump output voltage, VCP. The current control circuitry 134 produces the control signals 136 (HS_{DRV} and LS_{DRV} in this example) as PWM signals having a duty cycle that is controlled by the charge pump output voltage, VCP. Thus, as described above, the current sensing circuitry 114b provides information (e.g., the pulse signal D_{COMP}) about the average value of the inductor current, i_{L}, and the current control circuitry 134 generates the control signals 136 to control the switching cycle of the transistors Q1 and Q2 to drive the average inductor current to the target threshold value, I_{TH}, set by the regulation signal, V_{ERR-V}.

The DC-DC power converter 100 and the control circuitry thereof can be implemented, in whole or in part, using control integrated circuits (ICs). In one example, the power conversion circuit 102, voltage control and current sensing loop 110, and the current control loop 130 are formed in a single IC (not shown). In various alternative implementations, one or more components of these circuits can be implemented outside of the IC. Moreover, one or more system components, such as the inductor 108, can be provided “off-chip” and coupled to the IC, for example.

As described above, the because the current sensing circuitry 114a, 114b provides access to the average inductor current, this information can be used to regulate a selected parameter of the DC-DC converter, such as the average output current or average input current, in some examples. This may provide an advantage of being able to regulate the average input or output current without requiring a lossy sense element to sense the input or output current to provide feedback information, which may improve accuracy and/or reduce cost. In the case of a buck configuration of the DC-DC converter 100, such as in the example of FIG. 4, the inductor current, i_{L}, corresponds to the output current delivered to the load via the output voltage terminal 106. Accordingly, the average inductor current can be used directly to regulate the average output current. However, in a buck-boost configuration of the DC-DC converter 100, such as in the example of FIG. 2A, the inductor current, it, is related to the input current at the input voltage terminal 104 and to the output current at the output voltage terminal 106, but does not directly correspond to either. Accordingly, in some examples, a conversion circuit can be used to convert the average inductor current, sensed using the current sensing circuitry 114a as described above, to regulate either the average input current or average output current of the DC-DC converter 100.

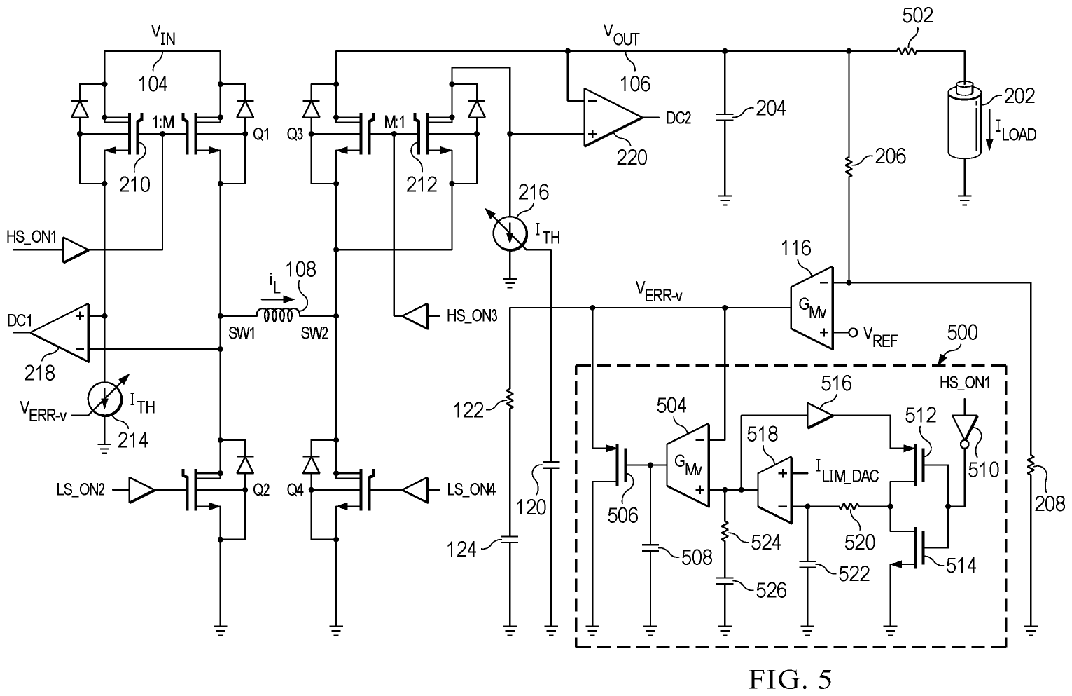

Referring to FIG. 5, there is illustrated an example of conversion circuit 500 for use in the DC-DC power converter 100 to regulate the input current at the input voltage terminal 104 based on the average inductor current, i_{L}. An optional sensing resistor 502 is coupled between the output voltage terminal 106 and the load 202. In this example, the conversion circuit 500 includes a first transconductance amplifier 504 having a first amplifier input terminal (labeled “−”) coupled to the output terminal of the transconductance amplifier 116 of the voltage regulator 112 to receive the regulation signal, V_{ERR-V}. A first transistor 506 is coupled between the output terminal of the transconductance amplifier 116 of the voltage regulator 112 and the ground terminal, and has a control terminal coupled to an output terminal of the first transconductance amplifier 504 of the conversion circuit 500. In the illustrated example, the first transistor 506 is a PMOS device; however, in other examples, other transistor technology may be used. A current limiting capacitor 508 may be coupled between the control terminal of the first transistor 506 (and the output terminal of the first transconductance amplifier 504) and the ground terminal, as shown.

The conversion circuit 500 may include first and second switching transistors 512, 514 having control terminals that are coupled together and coupled to an inverter 510 to receive a complementary version (e.g., with HIGH and LOW states reversed) of the first control signal HS_{ON1} that controls switching of the first high-side transistor Q1 as described above. In the illustrated example, the first switching transistor 512 is a PMOS device and the second switching transistor in an NMOS device. Accordingly, in this example, the first and second switching transistors 512, 514 have drain terminals that are coupled together and coupled, via a first RC filter, to a first amplifier input terminal (labeled “−”) of a second transconductance amplifier 518. In some examples, the first RC filter includes a resistor 520 coupled in series between the control terminals of the first and second switching transistors 512, 514 and the first amplifier input terminal of the second transconductance amplifier 518. The first RC filter may further include a shunt capacitor 522 coupled between the first amplifier input terminal of the second transconductance amplifier 518 and the ground terminal. The second transconductance amplifier 518 has a second amplifier input terminal (labeled “+”) coupled to receive a limit signal (I_{LIM_DAC}) that specifies a target value for the input current at the input voltage terminal 104. In some examples, the limit signal is suppled from a digital to analog converter (DAC) that may be part of the current control circuitry 134 or another on-chip of off-chip component of the DC-DC converter 100. An output terminal of the second transconductance amplifier 518 is coupled via a buffer 516 to a source terminal of the first switching transistor 512, and coupled to second amplifier input terminal (labeled “+”) of the first transconductance amplifier 504. A second RC filter may be coupled between the second amplifier input terminal of the first transconductance amplifier 504 (and therefore the output terminal of the second transconductance amplifier 518) and the ground terminal. In the illustrated example, the second RC filter includes a series combination of a resistor 524 and a capacitor 526. A source terminal of the second switching transistor 514 is coupled to the ground terminal.

In operation, the first and second switching transistors are turned on and off by the first control signal, HS_{ON1}. Accordingly, the switching transistors 512, 514 produce a voltage at the first amplifier input terminal of the second transconductance amplifier 518 that is proportional to the average of the inductor current, i_{L}, reflected back to the input voltage terminal 104. In some examples, this is achieved by multiplying the inductor current, i_{L}, by the duty cycle information represented by the control signal HS_{ON1}. The second transconductance amplifier 518 compares the limit signal, I_{LIM_DAC}, representing the target input current value, with the actual input reflected average inductor current (represented by the voltage at the first amplifier input terminal of the second transconductance amplifier 518). Thus, the conversion circuit 500 operates to limit the input current based on the limit signal, I_{LIM_DAC}. The conversion circuit 500 further regulates the input current through operation of the first transconductance amplifier 504 on the regulation signal, V_{ERR-V}, which as described above, is used to set the target value, I_{TH}, for the average inductor current, i_{L}, which in turn is produced, in part, by the input current flowing through the first high-side transistor Q1.

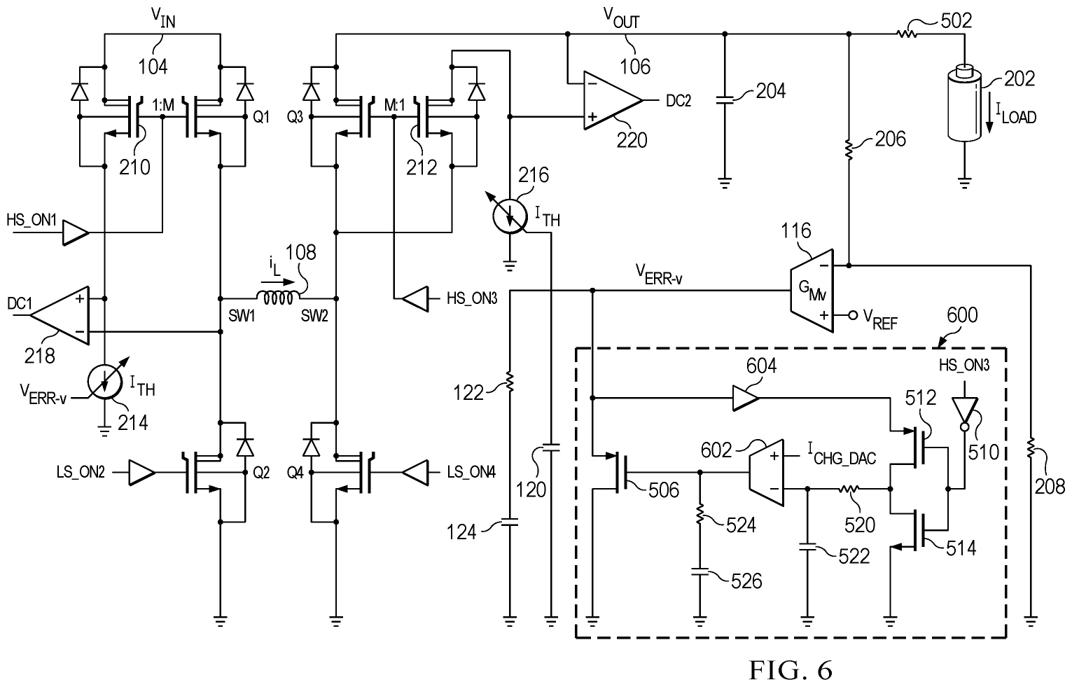

Referring to FIG. 6, there is illustrated an example of conversion circuit 600 for use in the DC-DC power converter 100 to regulate the output current at the output voltage terminal 106 based on the average inductor current, i_{L}. In this example, the conversion circuit 600 includes a transconductance amplifier 602 having a first amplifier input terminal (labeled “+”) coupled to receive a limit signal (I_{CHG_DAC}) that specifies a target value for the output current at the output voltage terminal 106. In some examples, the limit signal is suppled from a DAC that may be part of the current control circuitry 134 or another on-chip of off-chip component of the DC-DC converter 100. The conversion circuit 600 further includes the first transistor 506 and the first and second switching transistors 512, 514. In this example, the first transistor 506 is coupled between the output terminal of the transconductance amplifier 116 of the voltage regulator 112 and the ground terminal, and has a control terminal coupled to an output terminal of the transconductance amplifier 602 of the conversion circuit 600. The second RC filter (resistor 524 and capacitor 526) is coupled between the output terminal of the transconductance amplifier 602 (and therefore the control terminal of the first transistor 506) and the ground terminal.

In the example of FIG. 6, control terminals of the first and second switching transistors 512, 514 are coupled together and coupled to the inverter 510 to receive a complementary version (e.g., with HIGH and LOW states reversed) of the second control signal HS_{ON3} that controls switching of the second high-side transistor Q3 as described above. In this example, the first and second switching transistors 512, 514 have drain terminals that are coupled together and coupled, via the first RC filter (resistor 520 and capacitor 522 connected as described above), to a second amplifier input terminal (labeled “−”) of the transconductance amplifier 602. The source terminal of the first switching transistor 512 is coupled, via a buffer 604, to the output terminal of the transconductance amplifier 116 (and to the source terminal of the first transistor 506) to receive the regulation signal, V_{ERR-V}, as shown in FIG. 6. The source terminal of the second switching transistor 514 is coupled to the ground terminal.

In operation, the first and second switching transistors are turned on and off by the second control signal, HS_{ON3}. Accordingly, the switching transistors 512, 514 produce a voltage at the first amplifier input terminal of the transconductance amplifier 602 that is proportional to the average inductor current, i_{L}, reflected to the output voltage terminal 106. In some examples, this is achieved by multiplying the inductor current, in, by the duty cycle information represented by the control signal HS_{ON3}. The transconductance amplifier 602 compares the limit signal, I_{CHG_DAC}, representing the target output current value, with the actual output reflected average inductor current (represented by the voltage at the first amplifier input terminal of the transconductance amplifier 602). Furthermore, because the source terminal of the first switching transistor 512 receives the regulation signal, V_{ERR-V}, the current flowing through the resistor 520 to the second amplifier input terminal of the transconductance amplifier 602 has a value that is set by the target value for the average inductor current, in. Thus, the output current is represented in the conversion circuit 600 through the conversion of the target inductor current based on the portion of the inductor current that corresponds to the output current (flowing through the second high-side transistor Q3, when on). The conversion circuit 600 then operates to regulate the output current based on the limit signal, I_{CHG_DAC}.

Thus, using the conversion circuits 500 and/or 600, the input current and/or output current in the DC-DC converter 100 may be regulated by using the average inductor current information and therefore without requiring a sensing element to directly sense the input and/or output current. As described above, in some examples, the average inductor current information can be obtained in an accurate and lossless manner using the current sensing circuitry 114a. Accordingly, examples disclosed herein facilitate accurate control and/or limiting of average input and/or output current in the DC-DC power converter 100 for various benefits, such as improved system performance, reduced device degradation, and/or improved power efficiency and power density, for example. In addition, examples disclosed herein may offer the advantages of protecting a power source at the input of the DC-DC power converter 100 while delivering maximum power via input current regulation, or delivering a constant current to the connected load 202 via output current regulation. In some instances, the advantages associated with output current regulation may be particularly beneficial in battery charger applications, for example.

### Further Examples

Example 1 is a circuit comprising: a voltage regulator circuit having a regulator input terminal for coupling to an output terminal of a DC-DC power converter, and a regulator output terminal, the voltage regulator circuit configured to produce, at the regulator output terminal, a regulation signal based on a voltage at the regulator input terminal; current sensing circuitry having at least one switching input terminal, a sense input terminal, and a sense output terminal, the at least one switching input terminal for coupling to at least one switching terminal of the DC-DC power converter, and the sense input terminal coupled to the regulator output terminal, the current sensing circuitry configured to produce a pulse signal at the sense output terminal, wherein the pulse signal is based on a voltage at the at least one switching input terminal and an adjustable threshold value, set by the regulation signal; and a current control loop circuit having a loop input terminal coupled to the sense output terminal, and one or more control output terminals each for coupling to a control terminal of a corresponding switching transistor of the DC-DC power converter, the current control loop circuit configured to generate switching control signals at the one or more control output terminals based on the pulse signal, wherein the switching control signals are pulse width modulated signals to control the one or more switching transistors to drive an average value of a current flowing through the at least one switching terminal to a target average current value corresponding to the adjustable threshold value.

Example 2 includes the circuit of Example 1, wherein the pulse signal has a duty cycle that represents a percentage of time that the current flowing through the at least one switching terminal is above the adjustable threshold value.

Example 3 includes the circuit of one of Examples 1 or 2, wherein the one or more switching transistors include a first switching transistor coupled to the at least one switching terminal and a second switching transistor coupled to the at least one switching terminal, and wherein the current sensing circuitry comprises a first comparator circuit having a first comparator output terminal and configured to provide a first comparator signal at the first comparator output terminal, the first comparator signal having a first state responsive to a first switch current flowing through the first switching transistor being greater than the adjustable threshold value, or a second state responsive to the first switch current being less than the adjustable threshold value; a second comparator circuit having a second comparator output terminal and configured to provide a second comparator signal at the second comparator output terminal, the second comparator signal having the first state responsive to a second switch current flowing through the second switching transistor being greater than the adjustable threshold value, or the second state responsive to second switch current being less than the adjustable threshold value; and an OR-gate having first and second OR-gate input terminals and an OR-gate output terminal, the first OR-gate input terminal coupled to the first comparator output terminal, the second OR-gate input terminal coupled to the second comparator output terminal, and the OR-gate output terminal coupled to the sense output terminal, the OR-gate configured to provide the pulse signal.

Example 4 includes the circuit of Example 3, wherein the at least one switching terminal comprises a first switching terminal and a second switching terminal, wherein the first comparator circuit comprises a first variable current source having a current value corresponding to the adjustable threshold value and controlled by the regulation signal, a first sense transistor for sensing the first switch current, and a first comparator having the first comparator output terminal, a first comparator input terminal coupled to the first sense transistor and the first variable current source, and a second comparator input terminal coupled to the first switching terminal, and wherein the second comparator circuit comprises a second variable current source having a current value corresponding to the adjustable threshold value and controlled by the regulation signal, a second sense transistor for sensing the second switch current, and a second comparator having the second comparator output terminal, a third comparator input terminal coupled to the second sense transistor and the second variable current source, and a fourth comparator input terminal coupled to the output terminal.

Example 5 includes the circuit of any one of Examples 1-4, wherein the current control loop circuit comprises a charge pump circuit having the loop input terminal and a charge pump output terminal, the charge pump circuit configured to generate a control voltage signal at the charge pump output terminal based on the pulse signal.

Example 6 includes the circuit of Example 5, wherein the current control loop circuit comprises current control circuitry coupled to the charge pump output terminal and configured to generate the switching control signals based on the control voltage signal and one or more reference signals.

Example 7 includes the circuit of Example 6, wherein the current control circuitry comprises at least one hysteretic comparator circuit.

Example 8 includes the circuit of any one of Examples 1-7, wherein the voltage regulator circuit comprises a transconductance amplifier having the regulator input terminal, an amplifier input terminal for receiving a reference voltage, and the regulator output terminal, and a resistive-capacitive filter coupled between the regulator output terminal and a ground terminal, wherein the voltage regulator circuit is configured to produce the regulation signal based on a difference between the voltage at the regulator input terminal and the reference voltage.

Example 9 is a DC-DC converter comprising the circuit of any one of Examples 1-8.

Example 10 includes the DC-DC converter of Example 9, wherein the DC-DC converter is a buck-boost power converter.

Example 11 is a DC-DC power converter having an input terminal and an output terminal and comprising: a power conversion circuit including a plurality of power transistors and having at least one switching terminal for coupling, via an inductor, to at least one of the input terminal or the output terminal, the plurality of power transistors configured to generate a current through the at least one switching terminal based on control signals received via individual control terminals; a voltage regulator circuit having a regulator input coupled to the output terminal, and a regulator output, the voltage regulator circuit configured to produce, at the regulator output, a regulation signal based on a voltage at the output terminal; current sensing circuitry coupled to the power conversion circuit and having a sense output and a sense input, the sense input coupled to the regulator output, the current sensing circuitry configured to produce, at the sense output, a pulse signal having a duty cycle that represents a percentage of time that current flowing through the at least one switching terminal is above a target value; and a current control loop circuit having a control loop input and a plurality of control loop outputs, the control loop input coupled to the sense output, and each of the control loop outputs coupled to a corresponding one of the control terminals, the current control loop circuit configured to generate the control signals as pulse width modulated signals based on the pulse signal to control the plurality of power transistors to adjust the current through at the at least one switching terminal to the target value.

Example 12 includes the DC-DC power converter of Example 11, wherein the current control loop circuit comprises a charge pump circuit having the control loop input and a charge pump output, the charge pump circuit configured to generate a control voltage signal at the charge pump output based on the pulse signal.

Example 13 includes the DC-DC power converter of one of Examples 11 or 12, wherein the plurality of power transistors includes a first power transistor and a second power transistor, and wherein the current sensing circuitry comprises a first comparator circuit having a first comparator output and configured to provide a first comparator signal at the first comparator output, the first comparator signal having a first state responsive to a first switch current flowing through the first power transistor being greater than the target value, or a second state responsive to the first switch current being less than the target value, a second comparator circuit having a second comparator output and configured to provide a second comparator signal at the second comparator output, the second comparator signal having a first state responsive to a second switch current flowing through the second power transistor being greater than the target value, or the second state responsive to second switch current being less than the target value, and an OR-gate having first and second OR-gate inputs and an OR-gate output, the first OR-gate input coupled to the first comparator output, the second OR-gate input coupled to the second comparator output, and the OR-gate output coupled to the sense output, the OR-gate configured to provide the pulse signal at the sense output based on an OR combination of the first comparator signal and the second comparator signal.

Example 14 includes the DC-DC power converter of Example 13, wherein the DC-DC power converter is a buck-boost power converter, wherein the at least one switching terminal includes a first switching terminal and a second switching terminal, wherein the first power transistor is coupled between the input terminal and the first switching terminal, and wherein the second power transistor is coupled between the output terminal and the second switching terminal.

Example 15 includes the DC-DC power converter of Example 14, wherein the plurality of power transistors comprises a third power transistor coupled between the first switching terminal and a ground terminal, and a fourth power transistor coupled between the second switching terminal and the ground terminal.

Example 16 includes the DC-DC power converter of one of Examples 14 or 15, wherein the first comparator circuit comprises a first variable current source coupled between the input terminal and a ground terminal, and having a current value corresponding to the target value and controlled by the regulation signal, a first sense transistor coupled between the input terminal and the first variable current source and having a control terminal coupled to the control terminal of the first power transistor, and a first comparator having the first comparator output, a first comparator input coupled to the first sense transistor and the first variable current source, and a second comparator input coupled to the first switching terminal. In addition, the second comparator circuit comprises a second variable current source coupled between the second switching terminal and the ground terminal, and having a current value corresponding to the target value and controlled by the regulation signal, a second sense transistor coupled between the second switching terminal and the second variable current source and having a control terminal coupled to the control terminal of the second power transistor, and a second comparator having the second comparator output, a third comparator input coupled to the second sense transistor and the second variable current source, and a fourth comparator input terminal coupled to the output terminal.

Example 17 includes the DC-DC power converter of any one of Examples 14-16, wherein the control loop outputs include a first control output coupled to the control terminal of the first power transistor and the control signals include a first control signal provided at the first control output, the DC-DC power converter comprising a current conversion circuit coupled to the regulator output and to the first control output, the current conversion circuit configured to adjust the regulation signal based on a limit value for an input current at the input termina.

Example 18 includes the DC-DC power converter of any one of Examples 14-16, wherein the control loop outputs include a first control output coupled to the control terminal of the second power transistor and the control signals include a first control signal provided at the first control output, the DC-DC power converter comprising a current conversion circuit coupled to the regulator output and to the first control output, the current conversion circuit configured to adjust the regulation signal based on a limit value for an output current at the output terminal.

Example 19 is a buck-boost DC-DC converter comprising a first power transistor coupled between an input terminal and a first switching terminal, a second power transistor coupled between an output terminal and a second switching terminal, a voltage regulator having a first regulator input coupled to the output terminal, a second regulator input for receiving a reference voltage, and a regulator output, a first variable current source coupled between the input terminal and a ground terminal, and having a first current control input coupled to the regulator output, and a first sense transistor coupled between the input terminal and the first variable current source and having a control terminal coupled to a first control terminal of the first power transistor. The buck-boost DC-DC converter further comprises a first comparator having first and second comparator inputs and a first comparator output, the first comparator input coupled to the first switching terminal, and the second comparator input coupled to the first sense transistor and the first variable current source, such that the first variable current source is coupled between the second comparator input and the ground terminal, a second variable current source coupled between the second switching terminal and the ground terminal, and having a second current control input terminal coupled to the regulator output, and a second sense transistor coupled between the second variable current source and the second switching terminal, and having a control terminal coupled to a second control terminal of the second power transistor. The buck-boost DC-DC converter further comprises a second comparator having a second comparator output, a third comparator input coupled to the output terminal, and a fourth comparator input coupled to the second sense transistor and the second variable current source, such that the second variable current source is coupled between the fourth comparator input and the ground terminal, and a current control loop coupled to first and second comparator outputs and to the first and second control terminals of the first and second power transistors, respectively, the current control loop configured to generate first and second control signals at the first and second control terminals, respectively, based on signals at the first and second comparator outputs.

Example 20 includes the buck-boost DC-DC converter of Example 19, wherein the current control loop comprises an OR-gate having a first gate input coupled to the first comparator output, a second gate input coupled to the second comparator output, and a gate output, a charge pump circuit having a charge pump input coupled to the gate output, and a charge pump output, and control circuitry coupled to the charge pump output and configured to generate the first and second control signals.

Example 21 includes the buck-boost DC-DC converter of Example 20, further comprising a third power transistor coupled between the first switching terminal and the ground terminal, and having a third control terminal, and a fourth power transistor coupled between the second switching terminal and the ground terminal, and having a fourth control terminal, wherein the current control loop is coupled to the third and fourth control terminals and configured to generate third and fourth control signals at the third and fourth control terminals, respectively, based on the signals at the first and second comparator outputs.

Example 22 includes the buck-boost DC-DC converter of any one of Examples 19-21, wherein the voltage regulator is configured to generate a regulation signal at the regulator output based on a difference between the reference voltage and a voltage signal at the first regulator input, and wherein the regulation signal controls current values of the first and second variable current sources.

Example 23 includes the buck-boost DC-DC converter of any one of Examples 19-22, comprising a resistive-capacitive filter coupled between the regulator output and the ground terminal.

Example 24 includes the buck-boost DC-DC converter of any one of Examples 19-23, wherein first regulator input is coupled to the output terminal via a voltage divider circuit.

Example 25 is a control circuit for a DC-DC power converter, the control circuit comprising: a voltage regulator circuit having a first regulator input terminal for coupling to an output terminal of the DC-DC power converter, a second regulator input terminal for receiving a reference voltage, and a regulator output terminal, the voltage regulator circuit configured to produce, at the regulator output terminal, a regulation signal based on a difference between a voltage at the first regulator input terminal and a reference voltage; current sensing circuitry having at least one sensing terminal for coupling to at least one switching terminal of the DC-DC power converter, a sense output terminal, and at least one sense control terminal coupled to the regulator output terminal, the current sensing circuitry configured to produce, at the sense output terminal, a pulse signal having a duty cycle that represents a percentage of time that a current through the at least one switching terminal is above a target value that is based on the regulation signal; and a current control loop circuit having a loop input terminal coupled to the sense output terminal, and one or more control output terminals for coupling to power transistors, the current control loop circuit configured to generate, based on the pulse signal, control signals at the one or more control output terminals to control the power transistors to adjust the current through at the at least one switching terminal to the target value.

Example 26 is a buck-boost DC-DC power converter comprising: an input terminal; an output terminal; power conversion circuitry coupled to the input terminal and the output terminal and having first and second switching terminals for coupling to an inductor, the power conversion circuitry including a plurality of power transistors; a current control circuit coupled to the power conversion circuitry and configured to generate, based on a regulation signal, one or more control signals to control the plurality of power transistors to provide a regulated current; a regulator circuit coupled to the output terminal and to the power conversion circuitry, the regulator circuit having a regulator output terminal and configured to produce, at the regulator output terminal, the regulation signal representative of an average inductor current flowing through the first and second switching terminals; and a current conversion circuit coupled to the regulator output terminal and to the current control circuit, the current conversion circuit configured to adjust the regulation signal based on a limit signal representing a limit value for the regulated current.

Example 27 includes the buck-boost DC-DC power converter of Example 26, wherein the plurality of power transistors comprises a first power transistor coupled between the input terminal and the first switching terminal and having a first control terminal coupled to the current control signal to receive a first control signal of the one or more control signals, a second power transistor coupled between the first switching terminal and a ground terminal and having a second control terminal coupled to the current control circuit to receive a second control signal of the one or more control signals, a third power transistor coupled between the output terminal and the second switching terminal and having a third control terminal coupled to the current control circuit to receive a third control signal of the one or more control signals, and a fourth power transistor coupled between the second switching terminal and the ground terminal and having a fourth control terminal coupled to the current control circuit to receive a fourth control signal of the one or more control signals.

Example 28 includes the buck-boost DC-DC power converter of Example 27, wherein the regulated current is an input current at the input terminal.

Example 29 includes the buck-boost DC-DC power converter of Example 28, wherein the current conversion circuit comprises a switch circuit having a control input terminal coupled to the current control circuit to receive the first control signal, a first transconductance amplifier having a first amplifier input terminal for receiving the limit signal, a second amplifier input terminal coupled to the switch circuit, and a first amplifier output terminal, a second transconductance amplifier having a third amplifier input terminal coupled to the regulator output terminal, a fourth amplifier input terminal coupled to the first amplifier output terminal, and a second amplifier output terminal, and a transistor coupled between the regulator output terminal and the ground terminal and having a control terminal coupled to the second amplifier output terminal.

Example 30 includes the buck-boost DC-DC power converter of Example 29, wherein the current conversion circuit comprises a limit capacitor coupled between the second amplifier output terminal and the ground terminal.

Example 31 includes the buck-boost DC-DC power converter of Example 30, wherein the current conversion circuit comprises a first resistive capacitive filter including a first resistor coupled in series with a first capacitor between the first amplifier output terminal and the ground terminal, and a second resistive-capacitive filter including a second resistor coupled between the switch circuit and the second amplifier input terminal, and a second capacitor coupled between the second amplifier input terminal and the ground terminal.

Example 32 includes the buck-boost DC-DC power converter of Example 31, wherein the switch circuit comprises a buffer coupled to the first amplifier output terminal, a first switch transistor coupled between the buffer and the second resistor and having a control terminal coupled to the control input terminal, and a second switch transistor coupled between the second resistor and the ground terminal and having a second control terminal coupled to the control input terminal.

Example 33 includes the buck-boost DC-DC power converter of Example 27, wherein the regulated current is an output current at the output terminal.

Example 34 includes the buck-boost DC-DC power converter of Example 33, wherein the current conversion circuit comprises a switch circuit having a control input terminal coupled to the current control circuit to receive the third control signal, a transconductance amplifier having a first amplifier input terminal for receiving the limit signal, a second amplifier input terminal coupled to the switch circuit, and an amplifier output terminal, and a transistor coupled between the regulator output terminal and the ground terminal and having a control terminal coupled to the amplifier output terminal.

Example 35 includes the buck-boost DC-DC power converter of Example 34, wherein the current conversion circuit comprises a first resistive capacitive filter including a first resistor coupled in series with a first capacitor between the amplifier output terminal and the ground terminal, and a second resistive-capacitive filter including a second resistor coupled between the switch circuit and the second amplifier input terminal, and a second capacitor coupled between the second amplifier input terminal and the ground terminal.

Example 36 includes the buck-boost DC-DC power converter of Example 35, wherein the switch circuit comprises a buffer coupled to the regulator output terminal, a first switch transistor coupled between the buffer and the second resistor and having a control terminal coupled to the control input terminal, and a second switch transistor coupled between the second resistor and the ground terminal and having a second control terminal coupled to the control input terminal.

Example 37 is a buck-boost DC-DC power converter comprising an input terminal, an output terminal, first and second switching terminals for coupling to an inductor, a plurality of power transistors, including a first power transistor coupled between the input terminal and the first switching terminal, a voltage regulator circuit including a first regulator input terminal coupled to the output terminal, a second regulator input terminal for receiving a reference voltage, and a regulator output terminal, the voltage regulator circuit configured to provide, at the regulator output terminal, a regulation signal representative of a target average inductor current flowing through the first and second switching terminals, a current control circuit configured to regulate an input current at the input terminal to maintain the input current below a limit value, the current control circuit having a control output terminal coupled to a control terminal of the first power transistor and configured to provide a first control signal at the control output terminal, and a current conversion circuit. The current conversion circuit comprises a switch circuit having a switch control terminal coupled to the control output terminal, a first transconductance amplifier having a first amplifier input terminal coupled to the switch circuit, a second amplifier input terminal for receiving a limit signal, and a first amplifier output terminal, wherein the limit signal represents the limit value for the input current at the input terminal, a second transconductance amplifier having a third amplifier input terminal coupled to the regulator output terminal, a fourth amplifier input terminal coupled to the first amplifier output terminal, and a second amplifier output terminal, and a transistor coupled between the regulator output terminal and a ground terminal and having a control terminal coupled to the second amplifier output terminal.

Example 38 is a buck-boost DC-DC power converter comprising an input terminal, an output terminal, first and second switching terminals for coupling to an inductor, a plurality of power transistors, including a first power transistor coupled between the output terminal and the second switching terminal, a voltage regulator circuit including a first regulator input terminal coupled to the output terminal, a second regulator input terminal for receiving a reference voltage, and a regulator output terminal, the voltage regulator circuit configured to provide, at the regulator output terminal, a regulation signal representative of a target average inductor current flowing through the first and second switching terminals, a current control circuit configured to regulate an output current at the output terminal to maintain the output current below a limit value, the current control circuit having a control output terminal coupled to a control terminal of the first power transistor and configured to provide a first control signal at the control output terminal, and a current conversion circuit. The current conversion circuit comprises a switch circuit having a switch control terminal coupled to the control output terminal, a transconductance amplifier having a first amplifier input terminal coupled to the switch circuit, a second amplifier input terminal for receiving a limit signal, and an amplifier output terminal, wherein the limit signal represents the limit value for the output current at the output terminal, and a transistor coupled between the regulator output terminal and a ground terminal and having a control terminal coupled to the amplifier output terminal.

Example 39 is a method of controlling a DC-DC power converter, the method comprising generating a regulation signal based on a regulated parameter of the DC-DC power converter, generating a pulse signal having a duty cycle representing a percentage of time that an inductor current flowing at one or more switching terminals of the DC-DC converter is above a target value set by the regulation signal, based on the pulse signal, generating one or more control signals, and controlling one or more power transistors of the DC-DC power converter with the control signals to drive an average value of the inductor current to the target value.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described examples, and other examples are possible within the scope of the claims.

1. A circuit comprising:
a voltage regulator circuit having a regulator input terminal for coupling to an output terminal of a DC-DC power converter, and a regulator output terminal, the voltage regulator circuit configured to produce, at the regulator output terminal, a regulation signal based on a voltage at the regulator input terminal;
current sensing circuitry having at least one switching input terminal, a sense input terminal, and a sense output terminal, the at least one switching input terminal for coupling to at least one switching terminal of the DC-DC power converter, and the sense input terminal coupled to the regulator output terminal, the current sensing circuitry configured to produce a pulse signal at the sense output terminal, wherein the pulse signal is based on a voltage at the at least one switching input terminal and an adjustable threshold value, set by the regulation signal; and
a current control loop circuit having a loop input terminal coupled to the sense output terminal, and one or more control output terminals for coupling to respective control terminals of corresponding one or more switching transistors of the DC-DC power converter, the current control loop circuit configured to generate switching control signals at the one or more control output terminals based on the pulse signal, wherein the switching control signals are pulse width modulated signals to control the one or more switching transistors to drive an average value of a current flowing through the at least one switching terminal to a target average current value corresponding to the adjustable threshold value.

2. The circuit of claim 1, wherein the pulse signal has a duty cycle that represents a percentage of time that the current flowing through the at least one switching terminal is above the adjustable threshold value.

3. The circuit of claim 1, wherein the one or more switching transistors include a first switching transistor coupled to the at least one switching terminal and a second switching transistor coupled to the at least one switching terminal, and wherein the current sensing circuitry comprises:
a first comparator circuit having a first comparator output terminal and configured to provide a first comparator signal at the first comparator output terminal, the first comparator signal having a first state responsive to a first switch current flowing through the first switching transistor being greater than the adjustable threshold value, or a second state responsive to the first switch current being less than the adjustable threshold value;
a second comparator circuit having a second comparator output terminal and configured to provide a second comparator signal at the second comparator output terminal, the second comparator signal having the first state responsive to a second switch current flowing through the second switching transistor being greater than the adjustable threshold value, or the second state responsive to second switch current being less than the adjustable threshold value; and
an OR-gate having first and second OR-gate input terminals and an OR-gate output terminal, the first OR-gate input terminal coupled to the first comparator output terminal, the second OR-gate input terminal coupled to the second comparator output terminal, and the OR-gate output terminal coupled to the sense output terminal, the OR-gate configured to provide the pulse signal.

4. The circuit of claim 3, wherein the at least one switching terminal comprises a first switching terminal and a second switching terminal, wherein:
the first comparator circuit comprises
a first variable current source having a current value corresponding to the adjustable threshold value and controlled by the regulation signal,
a first sense transistor for sensing the first switch current, and
a first comparator having the first comparator output terminal, a first comparator input terminal coupled to the first sense transistor and the first variable current source, and a second comparator input terminal coupled to the first switching terminal; and
the second comparator circuit comprises
a second variable current source having a current value corresponding to the adjustable threshold value and controlled by the regulation signal,
a second sense transistor for sensing the second switch current, and
a second comparator having the second comparator output terminal, a third comparator input terminal coupled to the second sense transistor and the second variable current source, and a fourth comparator input terminal coupled to the output terminal.

5. The circuit of claim 1, wherein the current control loop circuit comprises:
a charge pump circuit having the loop input terminal and a charge pump output terminal, the charge pump circuit configured to generate a control voltage signal at the charge pump output terminal based on the pulse signal.

6. The circuit of claim 5, wherein the current control loop circuit comprises current control circuitry coupled to the charge pump output terminal and configured to generate the switching control signals based on the control voltage signal and one or more reference signals.

7. The circuit of claim 6, wherein the current control circuitry comprises at least one hysteretic comparator circuit.

8. The circuit of claim 1, wherein the voltage regulator circuit comprises:
a transconductance amplifier having the regulator input terminal, an amplifier input terminal for receiving a reference voltage, and the regulator output terminal; and
a resistive-capacitive filter coupled between the regulator output terminal and a ground terminal;
wherein the voltage regulator circuit is configured to produce the regulation signal based on a difference between the voltage at the regulator input terminal and the reference voltage.

9. A DC-DC power converter having an input terminal and an output terminal and comprising:
a power conversion circuit including a plurality of power transistors and having at least one switching terminal for coupling, via an inductor, to at least one of the input terminal or the output terminal, the plurality of power transistors configured to generate a current through the at least one switching terminal based on control signals received via individual control terminals;
a voltage regulator circuit having a regulator input coupled to the output terminal, and a regulator output, the voltage regulator circuit configured to produce, at the regulator output, a regulation signal based on a voltage at the output terminal;
current sensing circuitry coupled to the power conversion circuit and having a sense output and a sense input, the sense input coupled to the regulator output, the current sensing circuitry configured to produce, at the sense output, a pulse signal having a duty cycle that represents a percentage of time that current flowing through the at least one switching terminal is above a target value; and
a current control loop circuit having a control loop input and a plurality of control loop outputs, the control loop input coupled to the sense output, and each of the control loop outputs coupled to a corresponding one of the control terminals, the current control loop circuit configured to generate the control signals as pulse width modulated signals based on the pulse signal to control the plurality of power transistors to adjust the current through at the at least one switching terminal to the target value.

10. The DC-DC power converter of claim 9, wherein the current control loop circuit comprises:
a charge pump circuit having the control loop input and a charge pump output, the charge pump circuit configured to generate a control voltage signal at the charge pump output based on the pulse signal.

11. The DC-DC power converter of claim 9, wherein the plurality of power transistors includes a first power transistor and a second power transistor, and wherein the current sensing circuitry comprises:
a first comparator circuit having a first comparator output and configured to provide a first comparator signal at the first comparator output, the first comparator signal having a first state responsive to a first switch current flowing through the first power transistor being greater than the target value, or a second state responsive to the first switch current being less than the target value;
a second comparator circuit having a second comparator output and configured to provide a second comparator signal at the second comparator output, the second comparator signal having a first state responsive to a second switch current flowing through the second power transistor being greater than the target value, or the second state responsive to second switch current being less than the target value; and
an OR-gate having first and second OR-gate inputs and an OR-gate output, the first OR-gate input coupled to the first comparator output, the second OR-gate input coupled to the second comparator output, and the OR-gate output coupled to the sense output, the OR-gate configured to provide the pulse signal at the sense output based on an OR combination of the first comparator signal and the second comparator signal.

12. The DC-DC power converter of claim 11, wherein the DC-DC power converter is a buck-boost power converter, wherein the at least one switching terminal includes a first switching terminal and a second switching terminal, wherein the first power transistor is coupled between the input terminal and the first switching terminal, and wherein the second power transistor is coupled between the output terminal and the second switching terminal.

13. The DC-DC power converter of claim 12, wherein the plurality of power transistors comprises:
a third power transistor coupled between the first switching terminal and a ground terminal; and
a fourth power transistor coupled between the second switching terminal and the ground terminal.

14. The DC-DC power converter of claim 12, wherein:
the first comparator circuit comprises
a first variable current source coupled between the input terminal and a ground terminal, and having a current value corresponding to the target value and controlled by the regulation signal,
a first sense transistor coupled between the input terminal and the first variable current source and having a control terminal coupled to the control terminal of the first power transistor, and
a first comparator having the first comparator output, a first comparator input coupled to the first sense transistor and the first variable current source, and a second comparator input coupled to the first switching terminal; and
the second comparator circuit comprises
a second variable current source coupled between the second switching terminal and the ground terminal, and having a current value corresponding to the target value and controlled by the regulation signal,
a second sense transistor coupled between the second switching terminal and the second variable current source and having a control terminal coupled to the control terminal of the second power transistor, and
a second comparator having the second comparator output, a third comparator input coupled to the second sense transistor and the second variable current source, and a fourth comparator input terminal coupled to the output terminal.

15. The DC-DC power converter of claim 12, wherein the control loop outputs include a first control output coupled to the control terminal of the first power transistor and the control signals include a first control signal provided at the first control output, the DC-DC power converter comprising:
a current conversion circuit coupled to the regulator output and to the first control output, the current conversion circuit configured to adjust the regulation signal based on a limit value for an input current at the input terminal.

16. The DC-DC power converter of claim 14, wherein the control loop outputs include a first control output coupled to the control terminal of the second power transistor and the control signals include a first control signal provided at the first control output, the DC-DC power converter comprising:
a current conversion circuit coupled to the regulator output and to the first control output, the current conversion circuit configured to adjust the regulation signal based on a limit value for an output current at the output terminal.

17. A buck-boost DC-DC converter comprising:
a first power transistor coupled between an input terminal and a first switching terminal;
a second power transistor coupled between an output terminal and a second switching terminal;
a voltage regulator having a first regulator input coupled to the output terminal, a second regulator input for receiving a reference voltage, and a regulator output;
a first variable current source coupled between the input terminal and a ground terminal, and having a first current control input coupled to the regulator output;
a first sense transistor coupled between the input terminal and the first variable current source and having a control terminal coupled to a first control terminal of the first power transistor;
a first comparator having first and second comparator inputs and a first comparator output, the first comparator input coupled to the first switching terminal, and the second comparator input coupled to the first sense transistor and the first variable current source, such that the first variable current source is coupled between the second comparator input and the ground terminal;
a second variable current source coupled between the second switching terminal and the ground terminal, and having a second current control input terminal coupled to the regulator output;
a second sense transistor coupled between the second variable current source and the second switching terminal, and having a control terminal coupled to a second control terminal of the second power transistor;
a second comparator having a second comparator output, a third comparator input coupled to the output terminal, and a fourth comparator input coupled to the second sense transistor and the second variable current source, such that the second variable current source is coupled between the fourth comparator input and the ground terminal; and
a current control loop coupled to first and second comparator outputs and to the first and second control terminals of the first and second power transistors, respectively, the current control loop configured to generate first and second control signals at the first and second control terminals, respectively, based on signals at the first and second comparator outputs.

18. The buck-boost DC-DC converter of claim 17, wherein the current control loop comprises:
an OR-gate having a first gate input coupled to the first comparator output, a second gate input coupled to the second comparator output, and a gate output;
a charge pump circuit having a charge pump input coupled to the gate output, and a charge pump output; and
control circuitry coupled to the charge pump output and configured to generate the first and second control signals.

19. The buck-boost DC-DC converter of claim 17, further comprising:
a third power transistor coupled between the first switching terminal and the ground terminal, and having a third control terminal; and
a fourth power transistor coupled between the second switching terminal and the ground terminal, and having a fourth control terminal;
wherein the current control loop is coupled to the third and fourth control terminals and configured to generate third and fourth control signals at the third and fourth control terminals, respectively, based on the signals at the first and second comparator outputs.

20. The buck-boost DC-DC converter of claim 17, wherein the voltage regulator is configured to generate a regulation signal at the regulator output based on a difference between the reference voltage and a voltage signal at the first regulator input, and wherein the regulation signal controls current values of the first and second variable current sources.
